(19) United States
(12) Patent Application Publication
(10) Pub. No.: US 2026/0079629 A1
(43) Pub. Date: Mar. 19, 2026

(54) MEMORY SYSTEM

(71) Applicant: Kioxia Corporation, Tokyo (JP)

(72) Inventors: Yuki KAWAGUCHI, Fujisawa Kanagawa (JP); Yoshihisa KOJIMA, Kawasaki Kanagawa (JP); Takehiko AMAKI, Yokohama Kanagawa (JP); Shunichi IGAHARA, Fujisawa Kanagawa (JP); Toshikatsu HIDA, Yokohama Kanagawa (JP)

(21) Appl. No.: 19/067,802

(22) Filed: Feb. 28, 2025

(30) Foreign Application Priority Data
Sep. 17, 2024 (JP) 2024-160038

(51) Int. Cl. G06F 3/06

(52) U.S. Cl. CPC G06F 3/0616; G06F 3/064; G06F 3/0679

(57) ABSTRACT

A memory system includes a nonvolatile memory and a memory controller. The nonvolatile memory includes a plurality of physical full blocks. Each of the plurality of physical full blocks includes a plurality of physical sub-blocks. The memory controller executes a data erase operation independently for each of the plurality of physical sub-blocks in each of the plurality of physical full blocks, and in each of the plurality of physical full blocks, sets all of the plurality of physical sub-blocks therein to a same storage mode. The storage mode set for a physical sub-block indicates the number of bits of data stored in a memory cell thereof.

### CROSS-REFERENCE TO RELATED APPLICATION(S)

This application is based upon and claims the benefit of priority from Japanese Patent Application No. 2024-160038, filed Sep. 17, 2024, the entire contents of which are incorporated herein by reference.

### FIELD

Embodiments described herein relate generally to a memory system.

### BACKGROUND

As memory systems, solid state drives (SSD) having a memory controller and a memory device are known. The memory device is, for example, a nonvolatile memory. The nonvolatile memory is, for example, a NAND flash memory.

### BRIEF DESCRIPTION OF THE DRAWINGS

FIG. 1 is a block diagram illustrating a configuration example of an information processing system that includes a memory system according to a first embodiment.

FIG. 2 is a block diagram illustrating a configuration example of a nonvolatile memory according to the first embodiment.

FIG. 3 is a circuit diagram of a memory cell array of the nonvolatile memory according to the first embodiment.

FIG. 4 is a schematic diagram illustrating a configuration example of blocks in the memory system according to the first embodiment.

FIG. 5 is a schematic diagram illustrating an operation example of the memory system according to the first embodiment.

FIG. 6 is a schematic diagram illustrating an operation example of a memory system according to a comparative example.

FIG. 7 is a block diagram illustrating a configuration example of a memory system according to a second embodiment.

FIG. 8 is a schematic diagram illustrating an example of validity ratios of data in the memory system according to the second embodiment.

FIG. 9 is a flowchart illustrating a first operation example of garbage collection in the memory system according to the second embodiment.

FIG. 10 is a flowchart illustrating a second operation example of garbage collection in the memory system according to the second embodiment.

FIG. 11 is a flowchart illustrating a third operation example of garbage collection in the memory system according to the second embodiment.

FIG. 12 is a block diagram illustrating a configuration example of a memory system according to a third embodiment.

FIG. 13 is a flowchart illustrating a first operation example of wear leveling in the memory system according to the third embodiment.

FIG. 14 is a flowchart illustrating a second operation example of wear leveling in the memory system according to the third embodiment.

FIG. 15 is a flowchart illustrating a third operation example of wear leveling in the memory system according to the third embodiment.

### DETAILED DESCRIPTION

Embodiments provide a memory system having improved performance and lifetime.

In general, according to one embodiment, a memory system includes a nonvolatile memory and a memory controller that is electrically connected to the nonvolatile memory. The nonvolatile memory includes a plurality of physical full blocks. Each of the plurality of physical full blocks includes a plurality of physical sub-blocks. The memory controller is configured to execute a data erase operation independently for each of the plurality of physical sub-blocks in each of the plurality of physical full blocks, and in each of the plurality of physical full blocks, set all of the plurality of physical sub-blocks therein to a same storage mode. The storage mode set for a physical sub-block indicates the number of bits of data stored in a memory cell thereof.

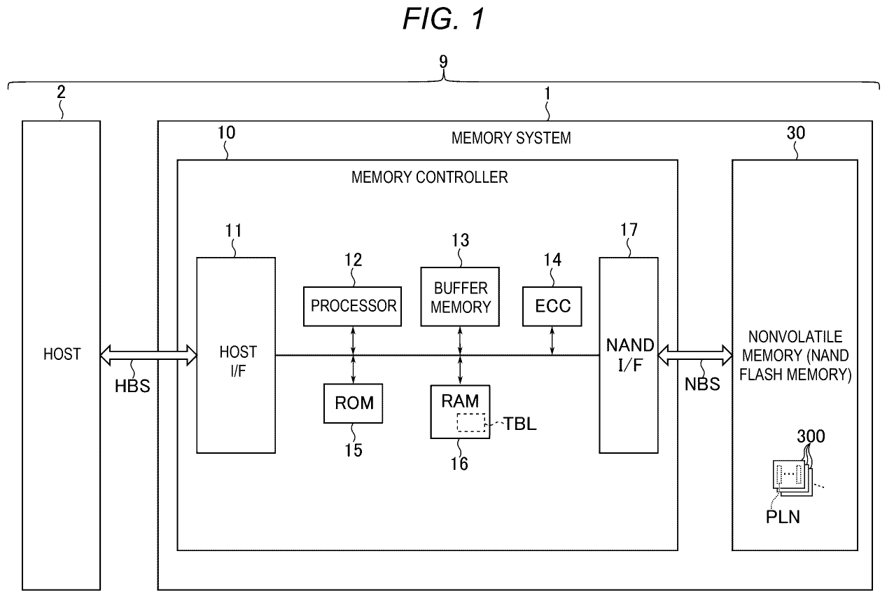

A memory system and a memory device according to embodiments will be described with reference to FIGS. 1 to 15. In the following descriptions, elements having substantially the same functions and configurations are represented by the same reference numerals and signs. Further, in each of the following embodiments, when elements (such as circuits, wiring, and various voltages and signals) which are given reference numerals and signs with distinguishing numerals and alphabets at the end, are not required to be distinguished from each other, the numerals and alphabets at the end omitted.

### (1) First Embodiment

A memory system according to a first embodiment and a control method thereof will be described with reference to FIGS. 1 to 6.

### (a) Configuration Example

FIG. 1 is a block diagram illustrating a configuration example of an information processing system 9. As shown in FIG. 1, the information processing system 9 includes a memory system 1 and a host 2.

The memory system 1 is a device that stores data. The memory system 1 is, for example, a solid state drive (SSD), a universal flash storage (UFS) device, a universal serial bus (USB) memory, a multi-media card (MMC), or an SD™ card. The memory system 1 can be connected to the host 2 via a host bus HBS. The memory system 1 performs processing based on a request (command or host command) received from the host 2 or a spontaneous processing request generated in the memory system 1.

The host 2 is a computing device that controls the memory system 1. The host 2 is, for example, a personal computer, a server, a mobile device, an in-vehicle device, or a digital camera.

(a-1-1) Internal Configuration of Memory System

The memory system 1 includes a memory controller 10 and a memory device 30. The memory device 30 is, for example, a nonvolatile memory. More specifically, the memory device 30 is a nonvolatile semiconductor memory such as a NAND flash memory. Hereinafter, the memory device 30 is referred to as a nonvolatile memory 30 or a NAND memory 30.

The memory controller 10 is a device that controls the NAND memory 30. The memory controller 10 is connected to the host 2 via the host bus HBS. The memory controller 10 receives requests from the host 2 via the host bus HBS. The type of the host bus HBS depends on an application applied to the memory system 1. When the memory system 1 is an SSD, the host bus HBS is based on, for example, the serial attached SCSI (SAS), serial ATA (SATA), or peripheral component interconnect express (PCIe™) standard. When the memory system 1 is a UFS device, the host bus HBS is based on the M-PHY standard. When the memory system 1 is a USB memory, the host bus HBS is based on the USB standard. When the memory system 1 is an SD™ card, the host bus HBS is based on the SD™ standard.

The memory controller 10 controls the NAND memory 30 via a NAND bus NBS, based on the request received from the host 2 or the spontaneous processing request generated in the memory system 1. The NAND bus NBS is based on, for example, the toggle NAND flash interface standard or the open NAND flash interface standard.

The NAND memory 30 is a device that stores data. The NAND memory 30 includes a plurality of memory cells. Each of the plurality of memory cells stores data in a nonvolatile manner in accordance with a threshold voltage of the memory cell. The NAND memory 30 stores data received from the memory controller 10 in a nonvolatile manner in the plurality of memory cells. The NAND memory 30 outputs data which is read from the plurality of memory cells to the memory controller 10.

(a-1-2) Memory Controller

An example of an internal configuration of the memory controller 10 will be described.

As shown in FIG. 1, the memory controller 10 includes a host interface circuit (host I/F) 11, a processor 12, a buffer memory 13, an error checking and correcting (ECC) circuit 14, a read only memory (ROM) 15, a random access memory (RAM) 16, and a NAND interface circuit (NAND I/F) 17. The memory controller 10 may be configured as, for example, a system-on-a-chip (SoC). The memory controller 10 may be configured with a plurality of chips. The functions of respective sections of the memory controller 10 may be implemented by a dedicated hardware circuit, a processor that executes a program (firmware), or a combination thereof.

The host interface circuit 11 is a circuit that has a function of communication between the memory controller 10 and the host 2. The host interface circuit 11 is connected to the host 2 via the host bus HBS.

The processor 12 is a control circuit of the memory controller 10. The processor 12 is, for example, a central processing unit (CPU). The processor 12 controls overall operations of the memory controller 10 by executing a program (firmware) stored in the ROM 15. For example, when the processor 12 receives a write request from the host 2, the processor 12 controls a write operation based on the received write request. A read operation is carried out in a similar manner.

The buffer memory 13 is a memory that temporarily stores data. The buffer memory 13 is, for example, a static random access memory (SRAM). The buffer memory 13 temporarily stores write data, read data, and the like. The write data is data that is to be written to the NAND memory 30. The read data is data that is read from the NAND memory 30.

The ECC circuit 14 is a circuit that performs ECC processing for correcting errors in data. The ECC circuit 14 generates an error correction code based on the write data in a predetermined unit during a data write operation. The ECC circuit 14 generates a syndrome based on the error correction code in a predetermined unit during a data read operation and detects errors. The ECC circuit 14 corrects the detected errors.

The ROM 15 is a nonvolatile memory. The ROM 15 is, for example, an electrically erasable programmable read-only memory (EEPROM™). The ROM 15 stores a program such as firmware.

The RAM 16 is a volatile memory. The RAM 16 is, for example, an SRAM or a dynamic random access memory (DRAM). The RAM 16 is used as a work area of the processor 12. The RAM 16 stores firmware for managing the NAND memory 30 and various kinds of management information. The RAM 16 stores, for example, various tables TBL.

The NAND interface circuit 17 is a circuit that has a function of communication between the memory controller 10 and the NAND memory 30. The NAND interface circuit 17 is electrically connected to the NAND memory 30 via the NAND bus NBS. For example, the NAND interface circuit 17 controls transfer of data, commands, addresses, and the like between the memory controller 10 and the NAND memory 30.

For example, the NAND memory 30 includes M memory chips (also referred to as memory dies) 300. One memory chip 300 includes N planes PLN. The plane PLN is a control unit capable of operating independently. Here, M and N are integers equal to or greater than 1.

(a-1-3) NAND Flash Memory

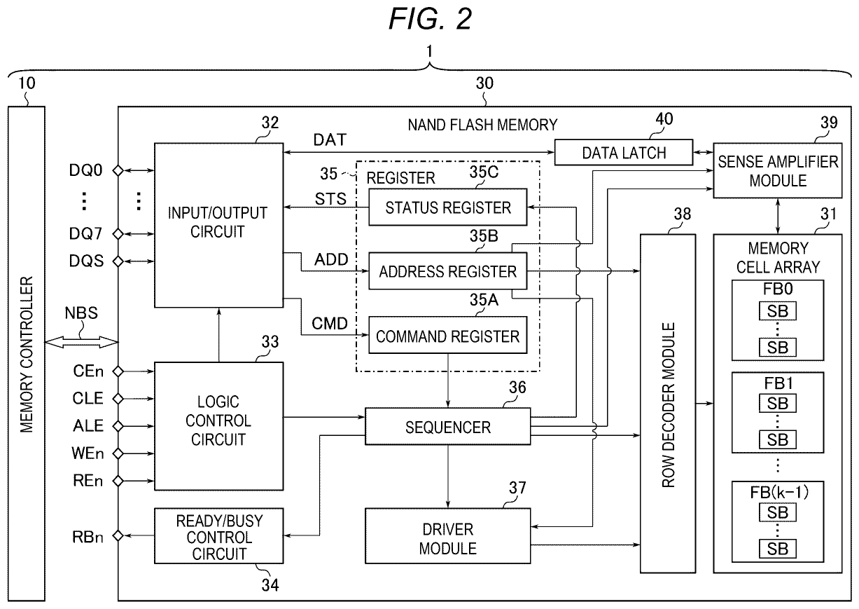

The configuration of the NAND memory 30 will be described with reference to FIG. 2.

FIG. 2 is a block diagram illustrating an example of a configuration of the NAND memory 30. FIG. 2 shows the configuration of one of the M memory chips 300 provided in the NAND memory 30 as an example of the configuration of the NAND memory 30. The NAND memory 30 includes a memory cell array 31, an input/output circuit 32, a logic control circuit 33, a ready/busy control circuit 34, a register 35, a sequencer 36, a driver module 37, a row decoder module 38, a sense amplifier module 39, and a data latch 40.

The memory cell array 31 is a circuit that stores data. The memory cell array 31 includes one or more physical full blocks FB0, FB1, . . . , and FB(k−1). Here, k is an integer of 1 or greater. For example, the memory cell array 31 may be divided into one or more planes PLN each including a plurality of physical full blocks. Each physical full block FB (FB0, FB1, . . . , and FB(k−1)) includes a plurality of physical sub-blocks SB. The physical sub-block SB is a control unit for various operations of the NAND memory 30. The physical sub-block SB is, for example, a set including a plurality of memory cells from which data is erased collectively. That is, the physical sub-block SB may be used as a unit of a data erase operation. In the following description, when the physical full block and the physical sub-block are not distinguished from each other, the blocks are referred to as physical blocks.

A plurality of bit lines and a plurality of word lines are provided in the memory cell array 31. Each memory cell is associated with, for example, one bit line and one word line. The details of the memory cell array 31 will be described later.

The input/output circuit 32 is a circuit that transmits and receives signals and information to and from the memory controller 10. The input/output circuit 32 transmits and receives input/output signals DQ (for example, 8-bit signals DQ0 to DQ7) and a data strobe signal DQS to and from the memory controller 10. The signal DQ is data transmitted and received between the NAND memory 30 and the memory controller 10. The signal DQ includes, for example, a command CMD, an address ADD, status information STS, and data DAT. The signal DQS is a signal (such as a clock signal) for controlling a timing of transmission and reception of the signal DQ. For example, when writing data, the signal DQS is transmitted from the memory controller 10 to the NAND memory 30 together with the signal DQ including the write data. The input/output circuit 32 receives the signal DQ including the write data in synchronization with the signal DQS. When reading data, the signal DQS is transmitted from the input/output circuit 32 to the memory controller 10 together with the signal DQ including the read data. The memory controller 10 receives the signal DQ including the read data in synchronization with the signal DQS. The input/output circuit 32 may receive the signal DQS from the memory controller 10 via the logic control circuit 33.

The input/output circuit 32 transmits the command CMD in the signal DQ to a command register 35A. The input/output circuit 32 transmits the address ADD in the signal DQ to an address register 35B. The input/output circuit 32 receives the status information STS from a status register 35C. The input/output circuit 32 transmits and receives the data DAT in the signal DQ to and from the data latch 40.

The logic control circuit 33 is a circuit that controls the input/output circuit 32 and the sequencer 36 based on a control signal. The logic control circuit 33 receives a chip enable signal CEn, a command latch enable signal CLE, an address latch enable signal ALE, a write enable signal WEn, and a read enable signal REn from the memory controller 10. The signal CEn is a signal for enabling the NAND memory 30 to operate. The signal CLE is a signal indicating that the signal DQ received by the NAND memory 30 is the command CMD. The signal ALE is a signal indicating that the signal DQ received by the NAND memory 30 is the address ADD. The signal WEn is a signal that instructs the NAND memory 30 to input the signal DQ. The signal REn is a signal that instructs the NAND memory 30 to output the signal DQ. The NAND memory 30 generates the signal DQS based on the signal REn. The NAND memory 30 outputs the signal DQ to the memory controller 10 based on the generated signal DQS.

The ready/busy control circuit 34 is a circuit that notifies the memory controller 10 of an operation status of the sequencer 36. The ready/busy control circuit 34 transmits a ready/busy signal RBn to the memory controller 10, based on the operation status of the sequencer 36. The signal RBn is a signal that indicates whether the NAND memory 30 is in a ready state or a busy state. For example, the signal level of the signal RBn is a high level (“H” level) when the NAND memory 30 is in the ready state. The ready state is a state where the NAND memory 30 is able to accept commands from the memory controller 10. The signal level of the signal RBn is a low level (“L” level), for example, when the NAND memory 30 is in the busy state. The busy state is a state where the NAND memory 30 is unable to accept commands from the memory controller 10.

The register 35 is a circuit that temporarily stores information. The register 35 includes the command register 35A, the address register 35B, and the status register 35C.

The command register 35A is a circuit that stores the command CMD. The command CMD includes, for example, a command to cause the sequencer 36 to execute the read operation, the write operation, or the erase operation.

The address register 35B is a circuit that stores the address ADD. The address ADD includes, for example, a row address and a column address. The row address includes a block address and a page address (which corresponds to a word line address). The block address, the page address, and the column address are used to respectively select, for example, a physical full block FB (or physical sub-block SB), a word line, and a bit line.

The status register 35C is a circuit that temporarily stores status information STS in, for example, the read operation, the write operation, or the erase operation. The status information STS is used to notify the memory controller 10 whether the operation ends correctly.

The sequencer 36 is a circuit that controls operations of other circuits of the NAND memory 30 in accordance with a predetermined program. The sequencer 36 controls the overall operations of the NAND memory 30. For example, the sequencer 36 controls the ready/busy control circuit 34, the driver module 37, the row decoder module 38, and the sense amplifier module 39, based on the command CMD stored in the command register 35A. For example, the sequencer 36 executes the read operation, the write operation, and the erase operation.

The driver module 37 is a circuit that generates various voltages used in the read operation, the write operation, and the erase operation. The driver module 37 applies the generated voltage to a signal line corresponding to a word line selected based on the page address stored in the address register 35B.

The row decoder module 38 is a circuit that selects one physical full block FB (or physical sub-block SB) in the memory cell array 31 based on the block address stored in the address register 35B. The row decoder module 38 transfers a voltage, which is to be applied to the signal line corresponding to the selected word line, to the selected word line in the selected physical full block FB (or physical sub-block SB).

In the write operation, the sense amplifier module 39 receives write data DAT from the input/output circuit 32 via the data latch 40. The sense amplifier module 39 applies a voltage based on the received write data DAT to the bit line. In the read operation, the sense amplifier module 39 determines data stored in the memory cell, based on whether a current flows through the bit line or based on the voltage of the bit line. The sense amplifier module 39 transfers the determination result as the read data DAT to the input/output circuit 32 via the data latch 40.

The data latch (also referred to as data cache) 40 includes a plurality of latch circuits (not shown in the drawing). Each latch circuit temporarily stores the write data or the read data. For example, in the write operation, the data latch 40 temporarily stores the write data received from the input/output circuit 32 and transmits the data to the sense amplifier module 39. In the read operation, the data latch 40 temporarily stores the read data received from the sense amplifier module 39 and transmits the data to the input/output circuit 32.

### Example of Circuit of Memory Cell Array

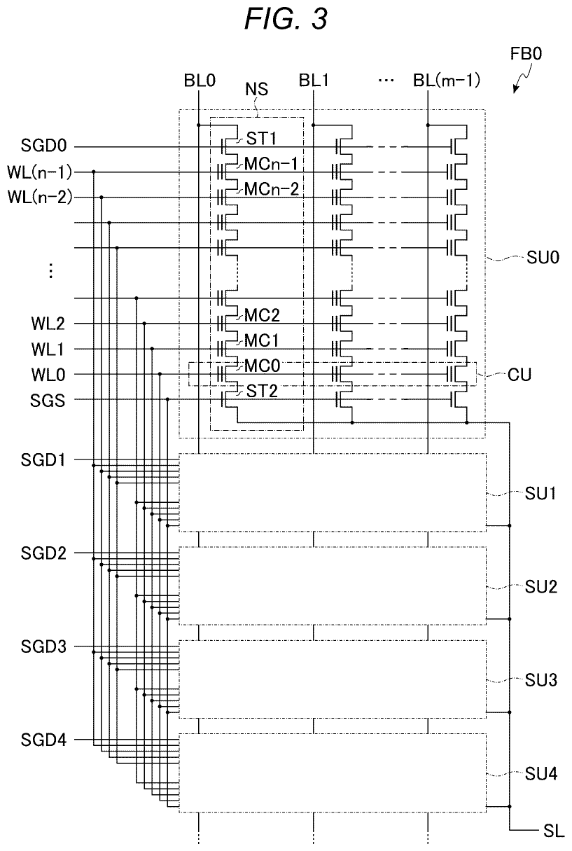

A circuit configuration of the memory cell array 31 will be described with reference to FIG. 3. FIG. 3 is a circuit diagram of the memory cell array 31. FIG. 3 shows a circuit configuration of a physical full block FB0 provided in the memory cell array 31 as an example of the circuit configuration of the memory cell array 31. The other physical full blocks FB have the same configuration as that shown in FIG. 3.

The physical full block FB0 includes, for example, five string units SU0, SU1, SU2, SU3, and SU4. Each string unit SU is, for example, a set including a plurality of NAND strings NS selected collectively in the write operation or the read operation. Each string unit SU includes the plurality of NAND strings NS respectively associated with bit lines BL0, BL1, . . . , and BL(m−1). Here, m is an integer of 1 or greater. The NAND string NS is a set including a plurality of memory cells MC (MC0, . . . , and MC(n−1)) connected in series. Each NAND string NS includes, for example, memory cells MC0, MC1, MC2, MC3, . . . , MC(n−2), and MC(n−1), a select transistor ST1, and a select transistor ST2. Here, n is an integer of 1 or greater. The memory cell (also referred to as a memory cell transistor) MC is a field effect transistor including a control gate and a charge storage layer. The select transistors ST1 and ST2 are switching elements. Each of the select transistors ST1 and ST2 is used to select a string unit SU during various operations.

In each NAND string NS, the memory cells MC0, . . . , and MC(n−1) are connected in series. The drain of the select transistor ST1 is connected to the associated bit line BL. The source of the select transistor ST1 is connected to one end of the memory cells MC0, . . . , and MC(n−1) connected in series. The drain of the select transistor ST2 is connected to the other end of the memory cells MC0, . . . , and MC(n−1) connected in series. The source of the select transistor ST2 is connected to a source line SL.

In the same physical full block FB, the control gates of the memory cells MC0, MC1, MC2, MC3, . . . , MC(n−2), and MC(n−1) are respectively connected in common to the word lines WL0, WL1, WL2, WL3, . . . , WL(n−2), and WL(n−1) across the plurality of NAND strings. The gates of the select transistors ST1 in the string units SU0, SU1, SU2, SU3, and SU4 are respectively connected in common to select gate lines SGD0, SGD1, SGD2, SGD3, and SGD4 across the plurality of NAND strings. The gates of the select transistors ST2 provided in the same block BLK are connected in common to a select gate line SGS across the plurality of NAND strings.

In the circuit configuration of the memory cell array 31 described above, the bit line BL is shared by, for example, the NAND strings NS to which the same column address is assigned in each string unit SU. The plurality of physical full blocks FB may share the source line SL.

The physical sub-block SB is a control unit that is configured as a unit of predetermined number of word lines WL or a unit of predetermined number of string units SU.

For example, in a physical full block FB including 96 word lines WL0 to WL95, a set including word lines WL0 to WL47 is assigned to a first physical sub-block SB, and a set including word lines WL48 to WL95 is assigned to a second physical sub-block SB. In such a case, one physical full block FB includes two physical sub-blocks SB. One physical full block FB also may include three physical sub-blocks SB. For example, a set including word lines WL0 to WL31 is assigned to a first physical sub-block SB, a set including word lines WL32 to WL63 is assigned to a second physical sub-block SB, and a set including word lines WL64 to WL95 is assigned to a third physical sub-block SB.

As another example, in a physical full block FB including six string units SU0 to SU5, a set including string units SU0 to SU2 is assigned to a first physical sub-block SB, and a set including string units SU3 to SU5 is assigned to a second physical sub-block SB. In such a case, one physical full block FB includes two physical sub-blocks SB. One physical full block FB also may include three physical sub-blocks SB. For example, a set including string units SU0 and SU1 is assigned to a first physical sub-block SB, a set including string units SU2 and SU3 is assigned to a second physical sub-block SB, and a set including string units SU4 and SU5 is assigned to a third physical sub-block SB.

As yet another example, a physical sub-block SB may be defined by the range of word lines WL and the string units SU. For example, four physical sub-blocks SB may be defined in a physical full block FB including 96 word lines WL0 to WL95 and six string units SU0 to SU5. In such a case, a set including word lines WL0 to WL47 of three string units SU0 to SU2 is assigned to a first physical sub-block SB, and a set including word lines WL0 to WL47 of three string units SU3 to SU5 is assigned to a second physical sub-block SB. In addition, a set including word lines WL48 to WL95 of three string units SU0 to SU2 is assigned to a third physical sub-block SB, and a set including word lines WL48 to WL95 of three string units SU3 to SU5 is assigned to a fourth physical sub-block SB.

In such a manner, a plurality of physical sub-blocks SB may be defined in each physical full block FB in accordance with the number of word lines WL and the configuration of the string units SU.

A set including the plurality of memory cells MC connected to the common word line WL in one string unit SU is referred to as, for example, a cell unit CU. A physical full block FB includes a plurality of cell units CU. Data stored in the cell unit CU including the plurality of memory cells MC each storing 1-bit data in accordance with a threshold voltage corresponds to one-page data. The cell unit CU is able to store one-or-more-page data based on the number of bits of data stored in each memory cell MC. When one memory cell MC stores 1-bit data, the memory cell MC is a single level cell (SLC). In such a case, the data stored in the cell unit CU corresponds to one-page data. When one memory cell MC stores 3-bit data, the memory cell MC is a triple level cell (TLC). In such a case, the data stored in the cell unit CU corresponds to three-page data. The number of bits of data, which can be stored in the memory cell MC, may be any real number. For example, the memory cell MC may be a multi level cell (MLC) that stores 2 bits of data, may be a quad level cell (QLC) that stores 4 bits of data, or may be a penta level cell (PLC) that stores 5 bits of data.

Hereinafter, a setting state (mode) indicating the number of bits of data stored in one memory cell MC is referred to as a storage mode. When the memory cell MC is an SLC, the storage mode is an SLC mode. When the memory cell MC is an MLC, the storage mode is an MLC mode. When the memory cell MC is a TLC, the storage mode is a TLC mode. When the memory cell MC is a QLC, the storage mode is a QLC mode. When the memory cell MC is a PLC, the storage mode is a PLC mode. The cell unit CU is able to store one-or-more-page data in accordance with the storage mode of the memory cell MC.

Changing the storage mode is referred to as a mode change. The number of bits which can be stored in one memory cell MC (also the number of pages assigned to one cell unit CU), is changed through the mode change.

Hereinafter, a case where either the SLC mode or the TLC mode is used as the storage mode will be given as an example.

The circuit configuration of the memory cell array 31 is not limited to the above-mentioned configuration. For example, the number of string units SU provided in a physical full block FB, and the number of memory cells MC and the number of select transistors ST1 and ST2 provided in each NAND string NS may be any number.

### Configuration Example of Blocks

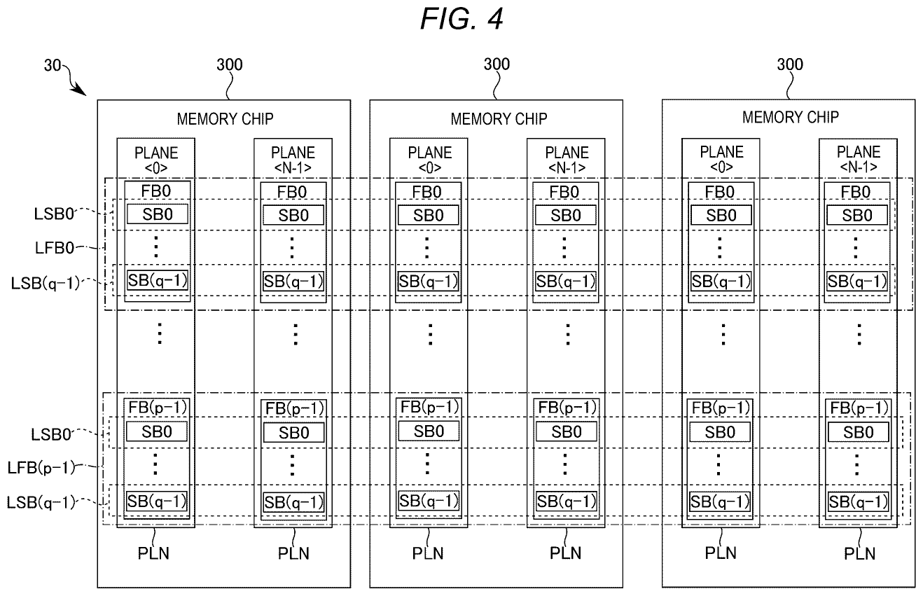

Various blocks of the NAND memory 30 in the memory system 1 according to the first embodiment will be described with reference to FIG. 4. FIG. 4 is a schematic diagram illustrating a configuration example of the blocks in the memory system 1 according to the first embodiment.

As described above, the NAND memory 30 includes a plurality of physical full blocks FB. Each physical full block FB includes a plurality of physical sub-blocks SB.

As shown in FIG. 4, a logical full block LFB is defined. The logical full block LFB is a set including physical full blocks FB that are accessible in parallel. However, in alternative embodiments, the logical full block LFB may include physical full blocks FB that are inaccessible in parallel. The logical full block LFB is a unit of an erase operation in a memory system that does not employ a logical sub-block LSB to be described later. The logical full block LFB is also referred to as a super full block SFB. The logical sub-block LSB is also referred to as a super sub-block SSB. In the following description, when the logical full block (or super full block) and the logical sub-block (or super sub-block) are not distinguished from each other, the blocks are referred to as logical blocks (or super blocks).

For example, the logical full block LFB includes the plurality of physical full blocks FB selected one by one from each of the N planes PLN of each of the M memory chips 300. In such a case, one logical full block LFB includes Mx N physical full blocks FB. When each plane PLN includes p physical full blocks FB0 to FB(p−1), p logical full blocks LFB0 to LFB(p−1) are formed in the memory system 1. Here, p is an integer equal to or greater than 1.

A plurality of logical sub-blocks LSB are defined in each logical full block LFB. For example, q logical sub-blocks LSB0 to LSB(q−1) are formed in one logical full block LFB. Here, q is an integer equal to or greater than 2. In such a case, p×q logical sub-blocks LSB are formed in the memory system 1. The logical sub-block LSB is, for example, a set including a plurality of physical sub-blocks SB that are accessible in parallel. The logical sub-block LSB is the unit of an erase operation in a memory system that employs the physical sub-blocks SB.

One logical sub-block LSB includes a plurality of physical sub-blocks SB. The number of physical sub-blocks SB provided in each of the logical sub-blocks LSB in one logical full block LFB is equal to each other.

FIG. 4 shows an example in which each logical sub-block LSB is formed across the plurality of memory chips 300. However, the logical sub-block LSB may be provided in one memory chip 300.

In the memory system 1 according to the first embodiment, the management table TBL of the memory controller 10 includes a table showing correspondence relationships between the logical full blocks LFB, the logical sub-blocks LSB, the physical full blocks FB, and the physical sub-blocks SB.

In the memory system 1 according to the first embodiment, one or more logical sub-blocks LSB are designated to be in one set of physical full blocks FB (for example, in one logical full block LFB). That is, a plurality of logical sub-blocks LSB are assigned in common to one set of physical full blocks FB.

For example, in first and second logical sub-blocks LSB (LSB0, LSB1) assigned to a set of two physical full blocks FB (physical full block FB0 and physical full block FB1) of the NAND memory 30, the first logical sub-block LSB0 includes one physical sub-block SB of the physical full block FB0 and one physical sub-block SB of the physical full block FB1. The second logical sub-block LSB1 includes another physical sub-block SB of the physical full block FB0 and another physical sub-block SB of the physical full block FB1.

In the memory system 1 according to the first embodiment, the memory controller 10 instructs the NAND memory 30 to perform various operations for which a storage mode is designated. For example, the memory controller 10 instructs the NAND memory 30 to perform various operations for which the storage mode is designated by adding a prefix command to a command sequence. The prefix command indicates the number of pages (the number of bits that one memory cell MC should store) assigned to one cell unit CU. For example, the memory controller 10 designates the storage mode when instructing the erase operation. More specifically, the memory controller 10 transmits an erase command sequence, which includes the prefix command, to the NAND memory 30. When a mode change is to be performed, the memory controller 10 instructs the NAND memory 30 to perform various operations for which the changed storage mode is designated.

When the logical sub-block LSB is defined in the memory system 1, the memory controller 10 instructs various operations for which the storage mode is designated in units of logical sub-blocks LSB. That is, the storage modes of all memory cells MC in all the physical sub-blocks SB provided in one logical sub-block LSB are the same.

The storage mode of the memory cells MC in the physical sub-blocks SB is changed from the SLC mode to the TLC mode, or from the TLC mode to the SLC mode, in accordance with the storage mode designated during the erase operation or the write operation.

As described above, the memory controller 10 designates the storage mode in units of the logical sub-block LSB. Therefore, when the memory controller 10 performs the mode change for a certain physical sub-block SB, other physical sub-blocks SB of the same logical sub-block LSB as the certain physical sub-block SB are also targets of the mode change.

The plurality of physical sub-blocks SB in one physical full block FB have a restriction that data is stored in the memory cells MC in the same storage mode. That is, in one physical full block FB, for example, a physical sub-block SB in the SLC mode and a physical sub-block SB in the TLC mode are not permitted to coexist at the same time. In one physical full block FB, all the physical sub-blocks SB are required to have the same storage mode in the data storage state. Therefore, when the memory controller 10 performs the mode change on a certain physical sub-block SB in a physical full block FB, the other physical sub-blocks SB in the physical full block FB are also targets of the mode change subsequently.

As a result, when a certain logical sub-block LSB is a target of the mode change, any physical sub-blocks SB in the same physical full block FB as a physical sub-block SB provided in the certain logical sub-block LSB are targets of the mode change. In such a manner, a plurality of logical sub-blocks LSB other than a logical sub-block LSB selected by the memory controller 10 as a target of the mode change becomes a target of the mode change.

In the memory system 1 according to the first embodiment, a plurality of logical sub-blocks LSB are assigned in common to one set of physical full blocks FB.

In such a manner, as will be described below, the memory system 1 according to the first embodiment is able to reduce the number of mode changes.

### (b) Operation Examples

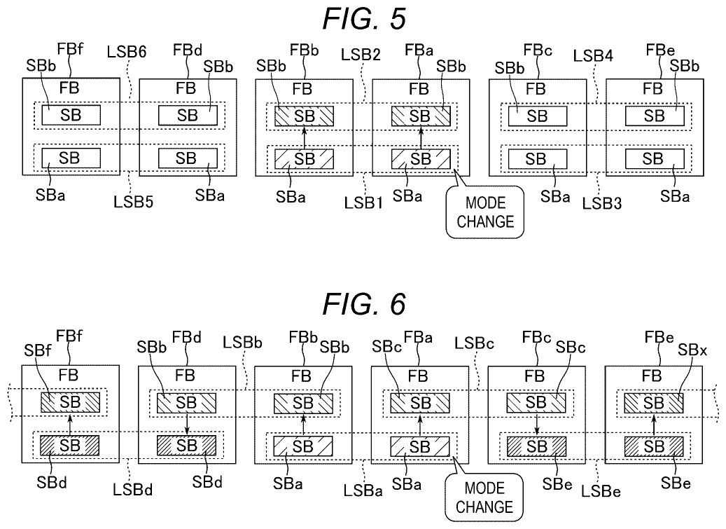

An operation example of the memory system 1 according to the first embodiment will be described with reference to FIG. 5.

FIG. 5 is a schematic diagram illustrating a state of the memory system 1 according to the first embodiment when the mode change occurs. In FIG. 5, six physical full blocks FB (FBa, FBb, FBc, FBd, FBc, and FBf) are provided, and two physical sub-blocks SB (SBa and SBb) are provided in each physical full block FB. Each of a plurality of logical sub-blocks LSB (LSB1, LSB2, LSB3, LSB4, LSB5, and LSB6) is assigned to one set of physical full blocks FB. Each logical sub-block LSB includes two physical sub-blocks SB. Two logical sub-blocks LSB are assigned to one set of two physical full blocks FB.

Specifically, the logical sub-block LSB1 includes the physical sub-block SBa of the physical full block FBa and the physical sub-block SBa of the physical full block FBb. The logical sub-block LSB2 includes the physical sub-block SBb of the physical full block FBa and the physical sub-block SBb of the physical full block FBb. That is, the set of physical full blocks FB (physical full blocks FBa and FBb) to which the logical sub-block LSB1 is assigned is the same as the set of physical full blocks FB (physical full blocks FBa and FBb) to which the logical sub-block LSB2 is assigned.

The logical sub-block LSB3 includes the physical sub-block SBa of the physical full block FBc and the physical sub-block SBa of the physical full block FBe. The logical sub-block LSB4 includes the physical sub-block SBb of the physical full block FBc and the physical sub-block SBb of the physical full block FBc. That is, the set of physical full blocks FB (physical full blocks FBc and FBc) to which the logical sub-block LSB3 is assigned is the same as the set of physical full blocks FB (physical full blocks FBc and FBc) to which the logical sub-block LSB4 is assigned.

The logical sub-block LSB5 includes the physical sub-block SBa of the physical full block FBd and the physical sub-block SBa of the physical full block FBf. The logical sub-block LSB6 includes the physical sub-block SBb of the physical full block FBd and the physical sub-block SBb of the physical full block FBf. That is, the set of physical full blocks FB (physical full blocks FBd and FBf) to which the logical sub-block LSB5 is assigned is the same as the set of physical full blocks FB (physical full blocks FBd and FBf) to which the logical sub-block LSB6 is assigned.

In the memory system 1 according to the first embodiment, the memory controller 10 selects the logical sub-block LSB to be a target of the mode change, for example, when the erase operation is instructed.

In the example shown in FIG. 5, it is assumed that the memory controller 10 selects the logical sub-block LSB1 as a target of the mode change.

Based on the storage mode designated in a command from the memory controller 10, the NAND memory 30 executes various kinds of processing and operations in the designated storage mode for the physical sub-blocks SBa of each of the physical full blocks FBa and FBb provided in the logical sub-block LSB1 as a target of the mode change.

Thereby, in the selected logical sub-block LSB1, the two physical sub-blocks SBa are subjected to the mode change, for example, from the TLC mode to the SLC mode or from the SLC mode to the TLC mode. In such a case, the physical sub-blocks SBa of the physical full block FBa of the logical sub-block LSB1 and the physical sub-blocks SBa of the physical full block FBb of the logical sub-block LSB1 are subjected to the mode change.

As described above, a restriction is present that all the physical sub-blocks SB of a physical full block FB are required to be set to the same storage mode. Therefore, the physical sub-block SBb of the same physical full block FBa as the physical sub-block SBa to be subjected to the mode change, and the physical sub-block SBb of the same physical full block FBb as the physical sub-block SBa to be subjected to the mode change, are subjected to the mode change subsequently. Note that the physical sub-blocks SBb in the physical full blocks FBa and FBb, which are to be subjected to the subsequent mode change, belong to the logical sub-block LSB2.

In the example shown in FIG. 5, the set of the physical full blocks FB (physical full blocks FBa and FBb) in which the logical sub-block LSB1 is set is the same as the set of the physical full blocks FB (physical full blocks FBa and FBb) in which the logical sub-block LSB2 is set. Thereby, in the memory system 1 according to the first embodiment, the subsequent actions of the mode change are completed within one set of the physical full blocks FB (that is, the set of physical full blocks including the physical full blocks FBa and FBb). The physical sub-blocks SB of the logical sub-blocks LSB3, LSB4, LSB5, and LSB6 assigned to the other sets of physical full blocks FBc, FBd, FBe, and FBf are not targets of the mode change.

The memory controller 10 reads data from the physical sub-blocks SB as a target of the mode change, copies the data to other physical sub-blocks SB, and then instructs the erase operation in the changed storage mode for the target physical sub-blocks SB.

As described above, the mode change operation in the memory system 1 according to the first embodiment is completed.

### (c) Comparative Example

FIG. 6 is a schematic diagram illustrating a state when a mode change occurs in a memory system of a comparative example. FIG. 6 shows an example in which six physical full blocks FB are provided and two physical sub-blocks SB are provided in each physical full block FB. A logical sub-block LSB includes two physical sub-blocks SB. Further, in the comparative example, it is assumed that a restriction is present that all the physical sub-blocks SB of a physical full block FB are required to be set to the same storage mode.

For example, a physical full block FBa includes a physical sub-block SBa and a physical sub-block SBc. A physical full block FBb includes a physical sub-block SBa and a physical sub-block SBb. A physical full block FBc includes a physical sub-block SBc and a physical sub-block SBe. A physical full block FBd includes a physical sub-block SBb and a physical sub-block SBd. A physical full block FBe includes a physical sub-block SBe and a physical sub-block SBx. A physical full block FBf includes a physical sub-block SBd and a physical sub-block SBf.

In the comparative example, each of logical sub-blocks LSBa, LSBb, LSBc, LSBd, LSBe, and LSBf is assigned to two physical full blocks FB. Each of the logical sub-blocks LSB in the comparative example is assigned to a different set of two physical full blocks FB.

Specifically, the logical sub-block LSBa includes the physical sub-block SBa of the physical full block FBa and the physical sub-block SBa of the physical full block FBb. The logical sub-block LSBc includes the physical sub-block SBc of the physical full block FBa and the physical sub-block SBc of the physical full block FBc. That is, the set of the physical full blocks FB (physical full blocks FBa and FBb) to which the logical sub-block LSBa is assigned, is different from the set of the physical full blocks FB (physical full blocks FBa and FBc) to which the logical sub-block LSBc is assigned.

The logical sub-block LSBb includes the physical sub-block SBb of the physical full block FBb and the physical sub-block SBb of the physical full block FBd. The logical sub-block LSBd includes the physical sub-block SBd of the physical full block FBd and the physical sub-block SBd of the physical full block FBf. That is, the set of the physical full blocks FB (physical full blocks FBb and FBd) to which the logical sub-block LSBb is assigned, is different from the set of the physical full blocks FB (physical full blocks FBa and FBb) to which the logical sub-block LSBa is assigned. Further, the set of the physical full blocks FB (physical full blocks FBb and FBd) to which the logical sub-block LSBb is assigned, is different from the set of the physical full blocks FB (physical full blocks FBd and FBf) to which the logical sub-block LSBd is assigned.

The logical sub-block LSBe includes the physical sub-block SBe of the physical full block FBc and the physical sub-block SBe of the physical full block FBe. That is, the set of the physical full blocks FB (physical full blocks FBc and FBe) to which the logical sub-block LSBe is assigned, is different from the set of the physical full blocks FB (physical full blocks FBa and FBc) to which the logical sub-block LSBc is assigned.

In the example shown in FIG. 6, it is assumed that the memory controller of the memory system of the comparative example selects the logical sub-block LSBa as a target of the mode change.

The NAND memory of the memory system of the comparative example executes various kinds of processing and operations in the designated storage mode, on the physical sub-block SBa of the physical full block FBa provided in the logical sub-block LSBa, and the physical sub-block SBa of the physical full block FBb provided in the logical sub-block LSBa, based on the designated storage mode provided in a command from the memory controller.

As described above, the restriction is present that all the physical sub-blocks SB of a physical full block FB are required to set to the same storage mode. Therefore, the logical sub-blocks LSBb and LSBc also become targets of the mode change, in conjunction with the mode change of the logical sub-block LSBa. That is, in the logical sub-block LSBb, in addition to the mode change of the physical sub-block SBb of the physical full block FBb, the physical sub-block SBb of the physical full block FBd is also a target of the mode change. Further, in the logical sub-block LSBc, in addition to the mode change of the physical sub-block SBc of the physical full block FBa, the physical sub-block SBc of the physical full block FBc is also a target of the mode change.

In accordance with the mode change for the logical sub-blocks LSBb and LSBc, the physical sub-block SBd of the physical full block FBd and the physical sub-block SBe of the physical full block FBc are also targets of the mode change.

Therefore, the logical sub-blocks LSBd and LSBe are also targets of the mode change. That is, in the logical sub-block LSBd, the physical sub-block SBd of the physical full block FBd and the physical sub-block SBd of the physical full block FBf are targets of the mode change. Further, the physical sub-block SBf of the physical full block FBf is also a target of the mode change. Furthermore, in the logical sub-block LSBe, the physical sub-block SBe of the physical full block FBc and the physical sub-block SBe of the physical full block FBe are targets of the mode change. Moreover, the other physical sub-block SBx of the physical full block FBe is also a target of the mode change.

The memory controller of the comparative example reads data from the physical sub-blocks SB as a target of the mode change, copies the data to other physical sub-blocks SB, and then instructs the erase operation in the changed storage mode for the target physical sub-blocks SB.

In the comparative example, a large number of physical sub-blocks SB become targets of the mode change subsequently in accordance with the allocation of logical sub-blocks LSB to a physical full block FB. As a result, an amount of data copied between the physical sub-blocks SB increases, and a write amplification factor (WAF) increases.

### (d) Summary

As a NAND memory progresses to successive generations, the size (storage capacity) of a physical full block increases. The number of physical full blocks provided in a memory system having the same user storage capacity has been decreasing in later generations of the NAND memory. Therefore, the overprovisioning (OP) ratio of the memory system is likely to decrease.

In order to secure the OP ratio, the application of sub-blocks as an erase unit is considered.

In the NAND memory to which the sub-blocks are applied, when a certain sub-block is targeted for a mode change, multiple sub-blocks other than the targeted sub-block are likely to be targeted for the mode change subsequently due to various restrictions of the NAND memory.

In the memory system 1 according to the first embodiment, a plurality of logical sub-blocks LSB are assigned in common to one set of physical full blocks FB. Thereby, according to the memory system 1 of the first embodiment, the subsequent mode changes are completed in the same set of the physical full blocks FB. Therefore, the memory system according to the first embodiment is able to reduce the number of sub-blocks to be targeted for the mode change.

Therefore, the memory system 1 according to the first embodiment is able to prevent the WAF from increasing.

As described above, the memory system 1 according to the first embodiment is able to improve performance of the memory system.

### (2) Second Embodiment

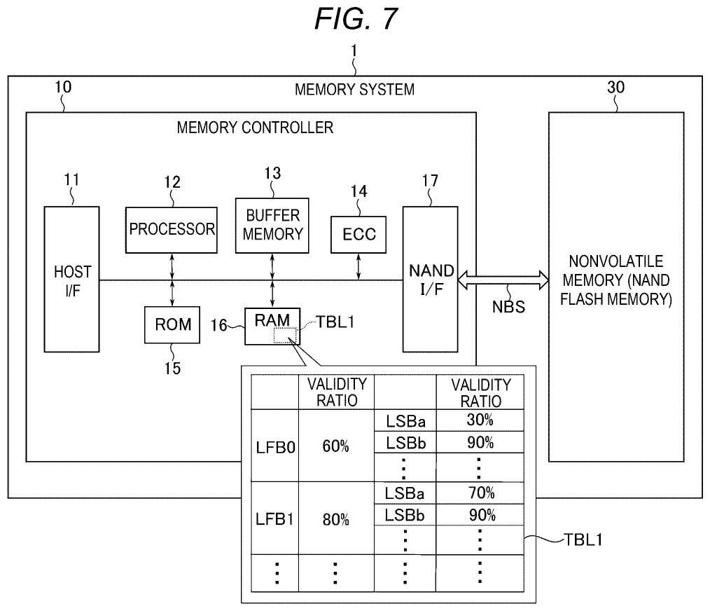

A memory system according to a second embodiment and a control method thereof will be described with reference to FIGS. 7 to 10.

### (a) Configuration Example

In the second embodiment, the memory controller 10 selects a logical full block as a target of garbage collection with the mode change, based on the validity ratio of data in the logical full block. Further, the memory controller 10 selects a logical sub-block as a target of garbage collection without the mode change, based on the validity ratio of data in the logical sub-block.

In the second embodiment, the memory controller 10 manages a logical block (logical full block or logical sub-block) as a user block (user logical full block or user logical sub-block) or a system block (system logical full block or system logical sub-block).

The user block is a logical block (logical full block or logical sub-block) in which data (user data) received from the host 2 is stored. The memory controller 10 uses a logical block that stores the user data in the SLC mode or the TLC mode as the user block.

The system block is a logical block (logical full block or logical sub-block) in which data relating to management of the memory system 1 is stored. The memory controller 10 uses a logical block that stores the management data in the SLC mode as the system block.

An example of data stored in the system block is a look up table (LUT) for managing a relationship between logical addresses designated by the host 2 and physical addresses of the NAND memory 30. The LUT has a plurality of entries. Each entry of the LUT stores information for managing mapping of each logical address to a physical address indicating a location in the NAND memory 30 in which user data having the logical address is stored. The memory controller 10 caches at least a part of the plurality of entries of the LUT in the RAM 16, for example, when the memory system 1 is started up. When the user data having the same logical address is written to the NAND memory 30 a plurality of times, the memory controller 10 stores the mapping information of the logical address in different entries of the LUT cached in the RAM 16. The memory controller 10 periodically or irregularly non-volatilizes the entries of the LUT cached in the RAM 16 into the NAND memory 30. The mapping information of the same logical address can be non-volatilized into the NAND memory 30 a plurality of times.

Hereinafter, a case where data stored in the system block is an LUT will be described as an example. Further, the system block is also referred to as an LUT block.

FIG. 7 is a block diagram illustrating the configuration example of the memory system 1 according to the second embodiment.

As shown in FIG. 7, the memory controller 10 stores, in the RAM 16, a management table TBL1 relating to the validity ratio of data of a plurality of logical full blocks LFB and the validity ratio of data of a plurality of logical sub-blocks LSB, during the operation of the memory system 1. Thereby, the memory controller 10 is able to find out the validity ratio of data of each logical full block LFB and the validity ratio of data of each logical sub-block LSB.

The memory controller 10 may manage the validity ratio of data separately for each use type of the logical block. For example, the memory controller 10 may manage the validity ratio of data of each logical block used as the LUT block. The memory controller 10 may manage the validity ratio of data of each logical block used as the user block in the SLC mode. Further, the memory controller 10 may manage the validity ratio of data of each logical block used as the user block in the TLC mode.

The validity ratio of data of a logical block (logical full block or logical sub-block) used as the user block is a ratio of the total amount of valid user data in the logical block to the storage capacity of the logical block. The valid user data is user data associated with a certain logical address which can be designated by the host 2. The invalid user data is user data that is not associated with any of the logical addresses which can be designated by the host 2. The valid user data is user data that can be requested to be read by the host 2. The invalid user data is user data that cannot be requested to be read by the host 2.

The validity ratio of data of a logical block (logical full block or logical sub-block) used as the LUT block is a ratio of the total amount of valid entries in the logical block to the storage capacity of the logical block. The valid entry is an entry that stores mapping information of a certain logical address which is non-volatilized lastly into the NAND memory 30, among mapping information of the certain logical address non-volatilized one or more times. The invalid entry is an entry that stores other mapping information of the certain logical address than the last non-volatilized one, among the mapping information of the certain logical address.

A logical block which is used as a user block but does not store valid user data, and a logical block which is used as an LUT block but does not store a valid entry, are referred to as a free logical block (free logical full block or free logical sub-block).

In the following description, the validity ratio of data is also simply referred to as the validity ratio. Further, when the valid user data and the valid entry are not distinguished from each other, the data and entry are referred to as valid data.

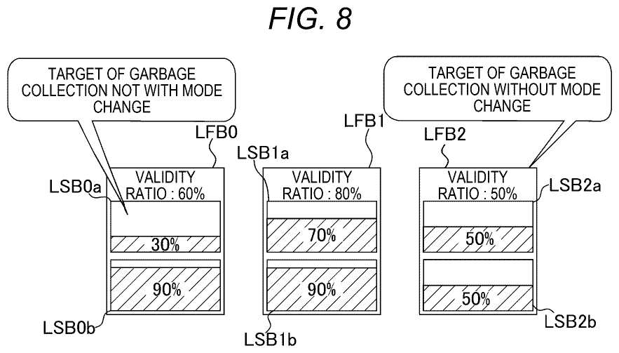

FIG. 8 is a schematic diagram illustrating an example of the validity ratio in the memory system according to the second embodiment.

FIG. 8 shows an example of three logical full blocks LFB0, LFB1, and LFB2. The logical full block LFB0 has a validity ratio of 60%, the logical full block LFB1 has a validity ratio of 80%, and the logical full block LFB2 has a validity ratio of 50%.

In FIG. 8, each logical full block LFB includes two logical sub-blocks LSBa and LSBb. In the logical full block LFB0, the logical sub-block LSB0a has a validity ratio of 30%, and the logical sub-block LSB0b has a validity ratio of 90%. In the logical full block LFB1, the logical sub-block LSB1a has a validity ratio of 70%, and the logical sub-block LSB1b has a validity ratio of 90%. In the logical full block LFB2, the logical sub-block LSB2a has a validity ratio of 50%, and the logical sub-block LSB2b has a validity ratio of 50%.

The memory controller 10 executes garbage collection as background processing based on a spontaneous processing request generated inside the memory system 1. The garbage collection is also referred to as a data copy operation, a data movement operation, a data transcription operation, or a data compaction operation. For example, the garbage collection may include two types of operation patterns including garbage collection with the mode change and garbage collection without the mode change. In the garbage collection, valid data is copied (moved) between a plurality of logical blocks. That is, the valid data, which is read from a copy source logical block, is written to a copy destination logical block. The garbage collection is executed, for example, when the number of free logical sub-blocks is equal to or smaller than a threshold value.

In the garbage collection with the mode change, for example, valid data, which is read from a certain logical sub-block LSB in a certain storage mode (for example, the SLC mode or the TLC mode), is written to another logical sub-block LSB in the same storage mode (for example, the SLC mode or the TLC mode). Then, the storage mode of the logical sub-block LSB of the copy source is changed, for example, from the SLC mode to the TLC mode, or from the TLC mode to the SLC mode.

In the second embodiment, when the garbage collection with the mode change is executed, the memory controller 10 selects a logical full block LFB as a target of the garbage collection from a plurality of logical full blocks LFB, based on the validity ratio of each of the plurality of logical full blocks LFB. For example, the memory controller 10 selects a logical full block LFB having the minimum validity ratio, as a target (that is, the copy source) of the garbage collection with the mode change, from the plurality of logical full blocks LFB. Then, the memory controller 10 executes the garbage collection on the selected logical full block LFB.

In the garbage collection without the mode change, valid data which is read from a certain logical sub-block LSB in a certain storage mode (for example, the SLC mode or the TLC mode) is written to another logical sub-block LSB in the same storage mode (for example, the SLC mode or the TLC mode). The storage mode of the logical sub-block LSB of the copy source is not changed.

In the present embodiment, when the garbage collection without the mode change is executed, the memory controller 10 selects a logical sub-block LSB as a target of the garbage collection from a plurality of logical sub-blocks LSB, based on the validity ratio of each of the plurality of logical sub-blocks LSB. For example, the memory controller 10 selects a logical sub-block LSB having the minimum validity ratio, as a target (that is, the copy source) of the garbage collection without the mode change, from the plurality of logical sub-blocks LSB. Then, the memory controller 10 executes the garbage collection on the selected logical sub-block LSB.

In the example of FIG. 8, among the three logical full blocks LFB0, LFB1, and LFB2, the logical full block LFB2 has the minimum validity ratio. The memory controller 10 selects the logical full block LFB2 as a target of the garbage collection with the mode change.

On the other hand, if the target of the garbage collection with the mode change is selected based on the validity ratio of the logical sub-block LSB, the logical sub-block LSB0a having the minimum validity ratio among the six logical sub-blocks LSB0a, LSB0b, LSB1a, LSB1b, LSB2a, and LSB2b is selected as the target. As described above, the restriction is present that physical sub-blocks SB of different storage modes may not coexist simultaneously in a physical full block FB. Therefore, when the logical sub-block LSB0a is selected, the entire logical full block LFB0 including the selected logical sub-block LSB0a is required to be targeted by the garbage collection. However, the logical full block LFB0 has a higher validity ratio than the logical full block LFB2. Therefore, the WAF would increase as compared to a case where the logical full block LFB2 is selected as a target of the garbage collection.

In the example of FIG. 8, among the six logical sub-blocks LSB0a, LSB0b, LSB1a, LSB1b, LSB2a, and LSB2b, the logical sub-block LSB0a has the minimum validity ratio. The memory controller 10 selects the logical sub-block LSB0a as a target of the garbage collection without the mode change.

On the other hand, if the target of the garbage collection without the mode change is selected based on the validity ratio of the logical full block LFB, the logical full block LFB2 having the minimum validity ratio among the three logical full blocks LFB0, LFB1, and LFB2 is selected as the target. That is, the logical sub-block LSB2a (or the logical sub-block LSB2b) in the logical full block LFB2 is targeted by the garbage collection. However, the logical sub-block LSB2a (or the logical sub-block LSB2b) has a higher validity ratio than the logical sub-block LSB0a. Therefore, the WAF would increase compared to a case where the logical sub-block LSB0a is selected as a target of the garbage collection.

As described above, the memory system 1 according to the second embodiment selects the target of the garbage collection without the mode change based on the validity ratio of the logical sub-block LSB, and selects the target of the garbage collection with the mode change based on the validity ratio of the logical full block LFB.

### (b) Operation Examples

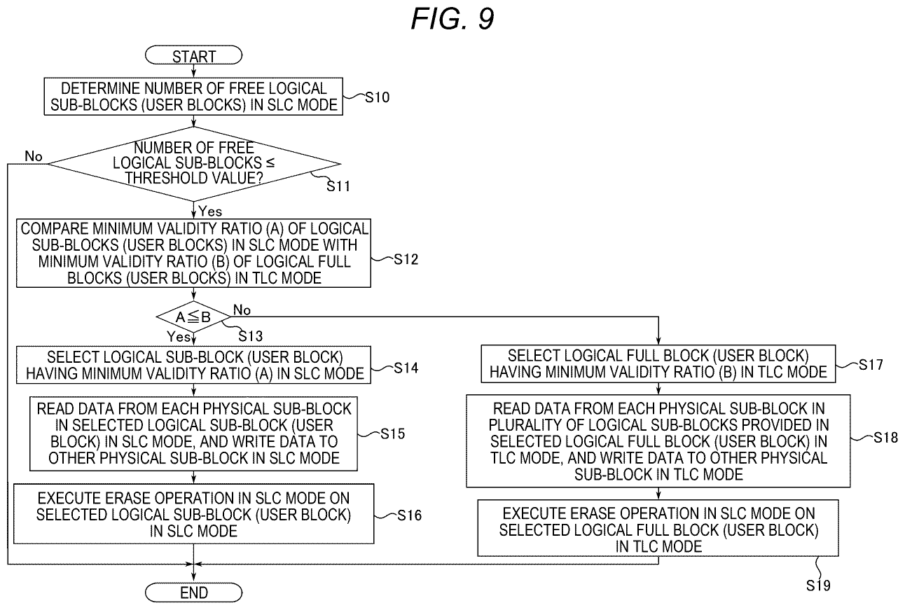

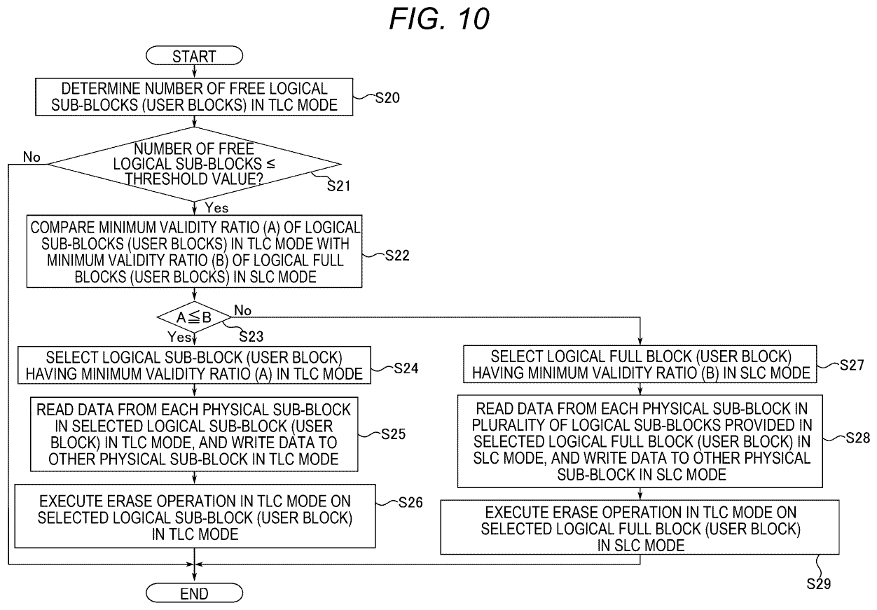

An operation example of the memory system 1 according to the second embodiment will be described with reference to FIGS. 9 to 11.

(b-1) Garbage Collection for User Blocks in SLC Mode

FIG. 9 is a flowchart illustrating the garbage collection processing for user blocks in the SLC mode in the memory system 1 according to the second embodiment. The processing shown in FIG. 9 is executed, for example, in response to the completion of writing user data to a certain logical sub-block LSB used as a user block in the SLC mode.

### (Step S10)

As shown in FIG. 9, the memory controller 10 determines the number of free logical sub-blocks allocated as user blocks in the SLC mode.

### (Step S11)

If the number of free logical sub-blocks allocated as the user blocks in the SLC mode is equal to or smaller than a threshold value (threshold value ThA) as shown “Yes” in Step S11, the processing executed by the memory controller 10 proceeds to Step S12. If the number of free logical sub-blocks allocated as the user blocks in the SLC mode is greater than the threshold value (threshold value ThA) as shown “No” in Step S11, the processing executed by the memory controller 10 ends.

### (Step S12)

The memory controller 10 refers to the management table TBL1 relating to the validity ratio of logical blocks. Then, the memory controller 10 searches for a logical block as a target of the garbage collection based on the validity ratio of the logical blocks. Specifically, the memory controller 10 compares the minimum validity ratio (A) among the validity ratios of the logical sub-blocks LSB used as the user blocks in the SLC mode, with the minimum validity ratio (B) among the validity ratios of the logical full blocks LFB used as the user blocks in the TLC mode.

### (Steps S13 and S14)

If the validity ratio (A) is equal to or lower than the validity ratio (B) as shown “Yes” in Step S13, the memory controller 10 selects the logical sub-block LSB (the user block in the SLC mode) having the validity ratio (A) as a target of the garbage collection (S14). In such a case, the garbage collection without the mode change is executed.

### (Step S15)

The memory controller 10 executes the garbage collection on the selected logical sub-block LSB (the user block in the SLC mode). Specifically, the memory controller 10 reads the valid data from each physical sub-block SB in the selected logical sub-block LSB. The read valid data is written to other physical sub-block(s) SB in the SLC mode. The memory controller 10 sets the logical sub-block LSB from which all the valid data is read as a free logical sub-block.

### (Step S16)

The memory controller 10 designates the SLC mode for each physical sub-block SB in the logical sub-block LSB which is set as the free logical sub-block, and executes the erase operation thereon. The logical sub-block LSB on which the erase operation is executed is used as the user block in the SLC mode. In such a case, the erase operation is not executed on the other logical sub-blocks LSB provided in a logical full block LFB that includes the logical sub-block LSB as a target of the garbage collection. Therefore, the storage mode of the other logical sub-blocks LSB does not change before and after the garbage collection is executed on the target logical sub-block LSB.

### (Steps S13 and S17)

Meanwhile, if the validity ratio (A) is higher than the validity ratio (B) as shown “No” in Step S13, the memory controller 10 selects the logical full block LFB (the user block in the TLC mode) having the validity ratio (B) as a target of the garbage collection (S17). In such a case, the garbage collection with the mode change is executed.

### (Step S18)

The memory controller 10 executes the garbage collection on the selected logical full block LFB (the user block in the TLC mode). Specifically, the memory controller 10 reads the valid data from each physical sub-block SB in the plurality of logical sub-blocks LSB provided in the selected logical full block LFB. The read valid data is written to other physical sub-block(s) SB in the TLC mode. The memory controller 10 sets the logical sub-block LSB from which all the valid data is read as a free logical sub-block.

### (Step S19)

The memory controller 10 designates the SLC mode for each physical sub-block SB in the logical sub-block LSB which is set as the free logical sub-block (that is, all the logical sub-blocks LSB provided in the logical full block LFB selected as a target of the garbage collection), and executes the erase operation thereon. In such a case, the storage mode of the logical full block LFB selected as the target of the garbage collection changes from the TLC mode to the SLC mode. Each logical sub-block LSB on which the erase operation is executed is used as the user block in the SLC mode.

As described above, the garbage collection for the user blocks in the SLC mode ends in the memory system according to the second embodiment.

(b-2) Garbage Collection for User Blocks in TLC Mode

FIG. 10 is a flowchart illustrating the garbage collection processing for user blocks in the TLC mode in the memory system 1 according to the second embodiment. The processing shown in FIG. 10 is executed, for example, in response to the completion of writing user data to a logical sub-block LSB used as the user block in the TLC mode.

### (Step S20)

As shown in FIG. 10, the memory controller 10 determines the number of free logical sub-blocks allocated as user blocks in the TLC mode.

### (Step S21)

If the number of free logical sub-blocks allocated as the user blocks in the TLC mode is equal to or smaller than a threshold value (threshold value ThB) as shown “Yes” in Step S21, the processing executed by the memory controller 10 proceeds to Step S22. If the number of free logical sub-blocks allocated as the user blocks in the TLC mode is greater than the threshold value (threshold value ThB) as shown “No” in Step S21, the processing executed by the memory controller 10 ends.

### (Step S22)

The memory controller 10 searches for a logical block as a target of the garbage collection, similar to the processing of Step S12 described with reference to FIG. 9. Specifically, the memory controller 10 compares the minimum validity ratio (A) among the validity ratios of the logical sub-blocks LSB used as the user blocks in the TLC mode with the minimum validity ratio (B) among the validity ratios of the logical full blocks LFB used as the user blocks in the SLC mode.

### (Steps S23 and S24)

If the validity ratio (A) is equal to or lower than the validity ratio (B) as shown “Yes” in Step S23, the memory controller 10 selects the logical sub-block LSB (the user block in the TLC mode) having the validity ratio (A) as a target of the garbage collection (S24). In such a case, the garbage collection without the mode change is executed.

### (Step S25)

The memory controller 10 executes the garbage collection on the selected logical sub-block LSB (the user block in the TLC mode) in a similar manner to the processing of Step S15 described with reference to FIG. 9.

### (Step S26)

The memory controller 10 designates the TLC mode for each physical sub-block SB in the logical sub-block LSB which is set as the free logical sub-block, and executes the erase operation thereon. The logical sub-block LSB on which the erase operation is executed is used as a user block in the TLC mode.

### (Steps S23 and S27)

Meanwhile, if the validity ratio (A) is higher than the validity ratio (B) as shown “No” in Step S23, the memory controller 10 selects the logical full block LFB (the user block in the SLC mode) having the validity ratio (B) as a target of the garbage collection (S27). In such a case, the garbage collection with the mode change is executed.

### (Step S28)

The memory controller 10 executes the garbage collection on the selected logical full block LFB (the user block in the SLC mode) in a similar manner to the processing of Step S18 described with reference to FIG. 9.

### (Step S29)

The memory controller 10 designates the TLC mode for each physical sub-block SB in the logical sub-block LSB which is set as the free logical sub-block (that is, all the logical sub-blocks LSB provided in the logical full block LFB selected as a target of the garbage collection), and executes the erase operation thereon.

As described above, the garbage collection for the user block in the TLC mode ends in the memory system according to the second embodiment.

(b-3) Garbage Collection for LUT Block in SLC Mode

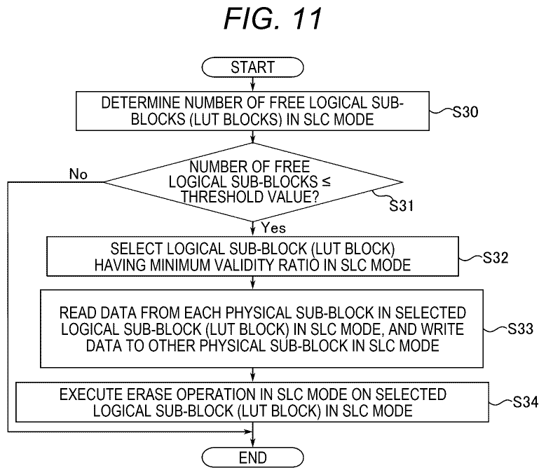

FIG. 11 is a flowchart illustrating the garbage collection processing for an LUT block in the SLC mode in the memory system 1 according to the second embodiment. The processing shown in FIG. 11 is executed, for example, in response to the completion of writing an entry to a logical sub-block LSB used as an LUT block in the SLC mode.

### (Step S30)

As shown in FIG. 11, the memory controller 10 determines the number of free logical sub-blocks allocated as the LUT blocks in the SLC mode.

### (Step S31)

If the number of free logical sub-blocks allocated as the LUT blocks in the SLC mode is equal to or smaller than a threshold value (threshold value ThC) as shown “Yes” in Step S31, the processing executed by the memory controller 10 proceeds to Step S32. If the number of free logical sub-blocks allocated as the LUT blocks in the SLC mode is greater than the threshold value (threshold value ThC) as shown “No” in Step S31, the processing executed by the memory controller 10 ends.

### (Step S32)

The memory controller 10 refers to the management table TBL1 relating to the validity ratio of the logical blocks. Then, the memory controller 10 searches for a logical block as a target of the garbage collection based on the validity ratio of the logical blocks. Specifically, the memory controller 10 selects a logical sub-block LSB having the minimum validity ratio, as a target of the garbage collection, from the logical sub-blocks LSB used as the LUT block in the SLC mode. In such a case, the garbage collection without the mode change is executed.

Alternatively, the memory controller 10 may select a logical block to be used as the LUT block in the SLC mode from the plurality of free logical blocks by a first-in first-out (FIFO) method. In such a case, the memory controller 10 may select, as a target of the garbage collection, a logical sub-block LSB with the oldest valid entry written, among the plurality of logical sub-blocks LSB used as the LUT block, instead of the logical sub-block LSB having the minimum validity ratio.

### (Step S33)

The memory controller 10 executes the garbage collection on the selected logical sub-block LSB (the LUT block in the SLC mode). Specifically, the memory controller 10 reads the valid entries from each physical sub-block SB in the selected logical sub-block LSB. The read valid entries are written to other physical sub-block(s) SB in the SLC mode. The memory controller 10 sets the logical sub-block LSB from which all valid entries are read as a free logical sub-block.

### (Step S34)

The memory controller 10 executes an erase operation by designating the SLC mode for each physical sub-block SB in the logical sub-block LSB which is set as the free logical sub-block. The logical sub-block LSB on which the erase operation is executed is used as an LUT block in the SLC mode.

As described above, the garbage collection for the LUT block in the SLC mode ends in the memory system according to the second embodiment.

### (c) Summary

In the memory system that does not employ logical sub-blocks, a logical full block having the minimum validity ratio among the plurality of logical full blocks may be selected as a target of garbage collection.

However, even when the validity ratio of the logical full block is the minimum, the logical sub-blocks provided in the logical full block do not necessarily have the minimum validity ratio among the plurality of logical sub-blocks. When the target of garbage collection without the mode change is selected in units of the logical full block, data is also copied from logical sub-blocks having a relatively high validity ratio. Thereby, the WAF is likely to increase.

In contrast, the memory system 1 according to the second embodiment selects a target of garbage collection without the mode change based on the validity ratio of each logical sub-block. Thereby, it is possible to prevent an increase in amount of valid data copied (moved) through the garbage collection without the mode change.

Since the mode change is not executed on the logical sub-block as a target of the garbage collection, the storage mode of other logical sub-blocks provided in the same logical full block as the target logical sub-block is not changed. Therefore, the other logical sub-blocks can keep stored valid data without being affected by the garbage collection. Therefore, when one or more of the other logical sub-blocks have a relatively high validity ratio, the high validity ratio can be kept.

Even when the validity ratio of a logical sub-block is the minimum, the logical full block that includes the logical sub-block does not necessarily have the minimum validity ratio among the plurality of logical full blocks. Further, the mode change targets all the logical sub-blocks provided in a logical full block as a target of the mode change. Therefore, when the target of the garbage collection with the mode change is selected in units of the logical sub-block, the data is likely to be copied from a logical full block having a relatively high validity ratio. Thereby, the WAF is likely to increase.

In contrast, the memory system 1 according to the second embodiment selects a target of the garbage collection with the mode change based on the validity ratio of each logical full block. Thereby, it is possible to prevent an increase in amount of valid data copied (moved) through the garbage collection with the mode change.

Therefore, the memory system 1 according to the second embodiment is able to improve the performance and lifetime of the memory system.

### (3) Third Embodiment

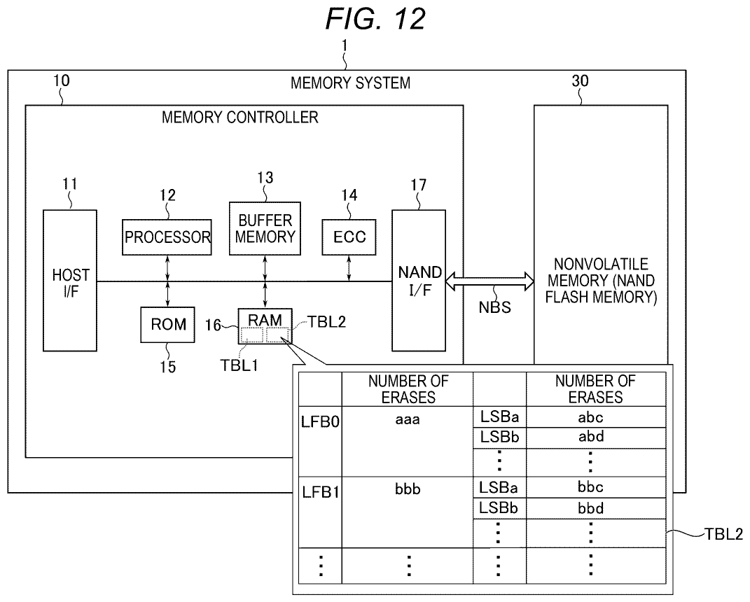

A memory system according to a third embodiment and a control method thereof will be described with reference to FIGS. 12 to 15.

### (a) Configuration Example

In the third embodiment, the memory controller 10 selects a logical full block as a target of wear leveling with the mode change, based on the degree of wear-out of the logical full block. Further, the memory controller 10 selects a logical sub-block as a target of wear leveling without the mode change, based on the degree of wear-out of the logical sub-block.

FIG. 12 is a block diagram illustrating a configuration example of the memory system 1 according to the third embodiment.

As shown in FIG. 12, during operation of the memory system 1, the memory controller 10 stores, in the RAM 16, a management table TBL2 relating to the degrees of wear-out of the plurality of logical full blocks LFB and the degrees of wear-out of the plurality of logical sub-blocks LSB, in addition to the management table TBL1 described with reference to FIG. 7. Thereby, the memory controller 10 finds out the degree of wear-out of each logical full block LFB and the degree of wear-out of each logical sub-block LSB.

The degree of wear-out of a certain logical full block LFB is determined, for example, based on the number of erase operations (number of erases) executed on each of the plurality of physical full blocks FB provided in the certain logical full block LFB. For example, the degree of wear-out of a certain logical full block LFB is determined based on the average value of the number of erase operations executed on each of the plurality of physical full blocks FB provided in the certain logical full block LFB. Alternatively, the degree of wear-out of a certain logical full block LFB is determined based on the maximum number of erase operations executed on each of the plurality of physical full blocks FB provided in the certain logical full block LFB. When the number of erases of a certain logical full block LFB is large, the degree of wear-out of the certain logical full block LFB is high.

The degree of wear-out of a certain logical sub-block LSB is determined, for example, based on the number of erase operations (number of erases) executed on each of the plurality of physical sub-blocks SB provided in the certain logical sub-block LSB. For example, the degree of wear-out of a certain logical sub-block LSB is determined based on the average value of the number of erase operations executed on each of the plurality of physical sub-blocks SB provided in the certain logical sub-block LSB. Alternatively, the degree of wear-out of a certain logical sub-block LSB is determined based on the maximum number of erase operations executed on each of the plurality of physical sub-blocks SB provided in the certain logical sub-block LSB. When the number of erases of a certain logical sub-block LSB is large, the degree of wear-out of the certain logical sub-block LSB is high.

The degree of wear-out of a certain physical full block FB is determined, for example, based on the number of erase operations (number of erases) executed on each of the plurality of physical sub-blocks SB provided in the certain physical full block FB. For example, the degree of wear-out of a certain physical full block FB is determined based on the average value of the number of erase operations executed on each of the plurality of physical sub-blocks SB provided in the certain physical full block FB. Alternatively, the degree of wear-out of a certain physical full block FB is determined based on the maximum number of erase operations executed on each of the plurality of physical sub-blocks SB provided in the certain physical full block FB. When the number of erases of a certain physical full block FB is large, the degree of wear-out of the certain physical full block FB is high.

The memory controller 10 may manage the degree of wear-out for each use type of the logical block. For example, the memory controller 10 may manage the degree of wear-out of each logical block used as an LUT block. The memory controller 10 may manage the degree of wear-out of each logical block used as a user block in the SLC mode. Further, the memory controller 10 may manage the degree of wear-out of each logical block used as a user block in the TLC mode.

The number of logical blocks (user blocks, LUT blocks) used in the SLC mode is less than the number of logical blocks (user blocks) used in the TLC mode. The total storage capacity of the logical blocks used in the SLC mode is less than the total storage capacity of the logical blocks used in the TLC mode. The wear-out of the logical blocks used in the SLC mode and the TLC mode is difficult to determine because it varies depending on the number thereof, the storage capacity thereof, and the pace of writing thereto. In general, the wear-out of the logical blocks used in the SLC mode is faster than the wear-out of the logical blocks used in the TLC mode.

The memory controller 10 executes the wear leveling as background processing based on a spontaneous processing request generated inside the memory system 1. The wear leveling is also referred to as a data copy operation, a data movement operation, or a data transcription operation. For example, the wear leveling may include two types of operation patterns including wear leveling with the mode change and wear leveling without the mode change. In the wear leveling, valid data is copied (moved) between a plurality of logical blocks. That is, the valid data, which is read from a copy source logical block, is written to a copy destination logical block. The wear leveling is executed, for example, when the difference in degree of wear-out between a plurality of logical blocks is equal to or greater than a threshold value.

In the wear leveling with the mode change, for example, valid data which is read from a certain logical sub-block LSB in a certain storage mode (for example, the SLC mode or the TLC mode) is written to another logical sub-block LSB in the same storage mode (for example, the SLC mode or the TLC mode). Then, the storage mode of the copy source logical sub-block LSB is changed, for example, from the SLC mode to the TLC mode or from the TLC mode to the SLC mode.

The wear leveling with the mode change is executed, for example, when a difference in degree of wear-out is present between a plurality of logical full blocks LFB of different storage modes. Specifically, the memory controller 10 selects a logical full block LFB having the minimum degree of wear-out as a target of the wear leveling (that is, copy source). When a plurality of logical full blocks LFB having the minimum degree of wear-out are present, the memory controller 10 selects a logical full block LFB to be targeted by the wear leveling based on the validity ratio of the logical full block LFB. Further, the memory controller 10 selects a logical full block LFB having the maximum degree of wear-out as a target of the wear leveling. When a plurality of logical full blocks LFB having the maximum degree of wear-out are present, the memory controller 10 selects a logical full block LFB to be targeted by the wear leveling based on the validity ratio of the logical full block LFB.

In the wear leveling without the mode change, valid data which is read from a certain logical sub-block LSB in a certain storage mode (for example, the SLC mode or the TLC mode) is written to another logical sub-block LSB in the same storage mode (for example, the SLC mode or the TLC mode). Then, the storage mode of the logical sub-block LSB of the copy source is not changed.

The wear leveling without the mode change is executed, for example, when a difference in degree of wear-out is present between a plurality of logical sub-blocks LSB in the same storage mode. Specifically, the memory controller 10 selects a logical sub-block LSB having the minimum degree of wear-out as a target of the wear leveling (that is, the copy source). When a plurality of logical sub-blocks LSB having the minimum degree of wear-out are present, the memory controller 10 selects a logical sub-block LSB to be targeted by the wear leveling based on the validity ratio of the logical sub-block LSB.

As described above, the memory system 1 according to the third embodiment selects a target of the wear leveling with the mode change based on the degree of wear-out of the logical full block LFB, and selects a target of the wear leveling without the mode change based on the degree of wear-out of the logical sub-block LSB.

### (b) Operation Examples

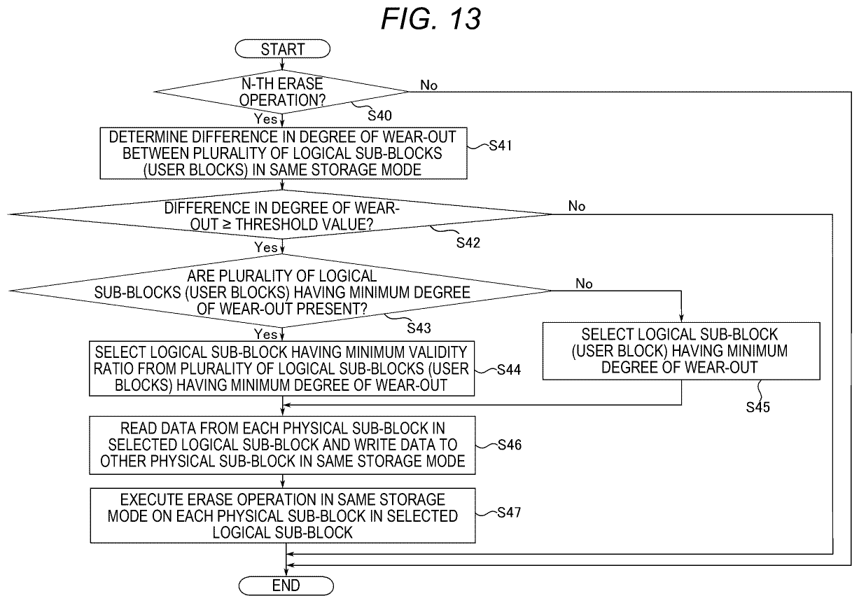

An operation example of the memory system 1 according to the third embodiment will be described with reference to FIGS. 13 to 15.

(b-1) Wear Leveling Between User Blocks

FIG. 13 is a flowchart illustrating processing of the wear leveling between user blocks in the memory system according to the third embodiment. The processing shown in FIG. 13 is executed, for example, in response to the completion of the erase operation on a certain logical sub-block LSB used as a user block.

### (Step S40)

The memory controller 10 manages the total number of erase operations executed on each of the plurality of logical sub-blocks LSB since the previous wear leveling is executed. As shown in FIG. 13, if the total number of erase operations reaches N due to the erase operation executed on a certain logical sub-block LSB as shown “Yes” in Step S40, the memory controller 10 resets the total number to 0, and the processing executed by the memory controller 10 proceeds to Step S41. If the total number of erase operations does not reach N as shown “No” in Step S40, the processing executed by the memory controller 10 ends. Here, N is an integer of 1 or greater. For example, N is 1000.

### (Step S41)

The memory controller 10 refers to the management table TBL2 relating to the degree of wear-out of logical blocks. Then, the memory controller 10 searches for a logical sub-block LSB as a target of the wear leveling based on the degree of wear-out of the logical sub-block LSB. Specifically, the memory controller 10 determines the difference in degree of wear-out between a plurality of logical sub-blocks LSB used as user blocks in the same storage mode. For example, the memory controller 10 calculates the difference between the average value of the respective degrees of wear-out of the plurality of logical sub-blocks LSB used as the user blocks in the same storage mode and the minimum degree of wear-out of the plurality of logical sub-blocks LSB used as the user blocks in the same storage mode.

### (Step S42)

If the difference in degree of wear-out is equal to or greater than the threshold value (threshold value ThD) as shown “Yes” in Step S42, the processing executed by the memory controller 10 proceeds to Step S43. In such a case, the wear leveling without the mode change is executed. If the difference in degree of wear-out is smaller than the threshold value (threshold value ThD) as shown “No” in Step S42, the processing executed by the memory controller 10 ends.

### (Step S43)

The memory controller 10 refers to the management table TBL2 relating to the degree of wear-out of logical blocks. Then, the memory controller 10 checks whether a plurality of logical sub-blocks LSB having the minimum degree of wear-out are present among the plurality of logical sub-blocks LSB used as the user blocks in the same storage mode. If the plurality of logical sub-blocks LSB having the minimum degree of wear-out are present as shown “Yes” in Step S43, the processing executed by the memory controller 10 proceeds to Step S44. If the plurality of logical sub-blocks LSB having the minimum degree of wear-out are not present as shown “No” in Step S43, the processing executed by the memory controller 10 proceeds to Step S45.

### (Step S44)

If the plurality of logical sub-blocks LSB having the minimum degree of wear-out are present as shown “Yes” in Step S43, the memory controller 10 refers to the management table TBL1 relating to the validity ratio of the logical block. Then, the memory controller 10 searches for a logical block as a target of the wear leveling based on the validity ratio of the logical block. Specifically, the memory controller 10 selects a logical sub-block LSB having the minimum validity ratio, as a target of the wear leveling, from the plurality of logical sub-blocks LSB having the minimum degree of wear-out.

### (Step S45)

If the plurality of logical sub-blocks LSB having the minimum degree of wear-out are not present as shown “No” in Step S43, the memory controller 10 selects the logical sub-block LSB having the minimum degree of wear-out as a target of the wear leveling.

### (Step S46)

The memory controller 10 executes the wear leveling on the selected logical sub-block LSB. Specifically, the memory controller 10 reads the valid data from each physical sub-block SB in the selected logical sub-block LSB. The read valid data is written to other physical sub-block(s) SB. The memory controller 10 writes the valid data to other physical sub-block(s) SB in the same storage mode as the storage mode of the physical sub-block SB from which the valid data is read. The memory controller 10 sets the logical sub-block LSB from which all the valid data is read as a free logical sub-block.

### (Step S47)

The memory controller 10 designates the same storage mode as before to each physical sub-block SB in the logical sub-block LSB which is set as the free logical sub-block, and executes the erase operation thereon. The logical sub-block LSB on which the erase operation is executed is used as a user block in the same storage mode as before. The logical sub-block LSB having the minimum degree of wear-out is used as the user block for writing new user data. Over time, it is expected that the degree of wear-out of the logical sub-block LSB and the degrees of wear-out of the other logical sub-blocks LSB will become equalized (leveled).

The erase operation is not executed on another logical sub-block LSB provided in a logical full block LFB that includes the logical sub-block LSB as the target of the wear leveling. Therefore, the storage mode of the other logical sub-blocks LSB does not change before and after the wear leveling is executed on the target logical sub-block LSB.

As described above, the wear leveling between user blocks ends in the memory system according to the third embodiment.

(b-2) Wear Leveling Between LUT Blocks

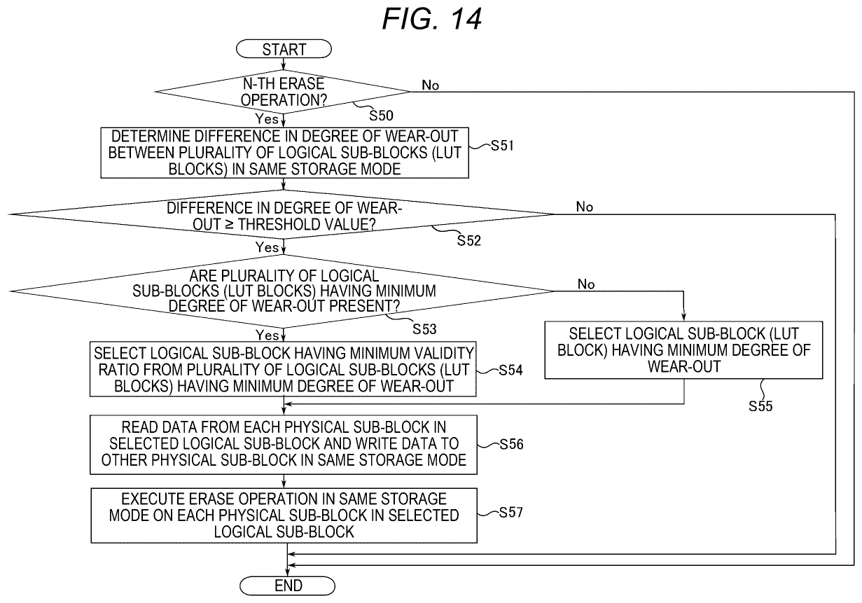

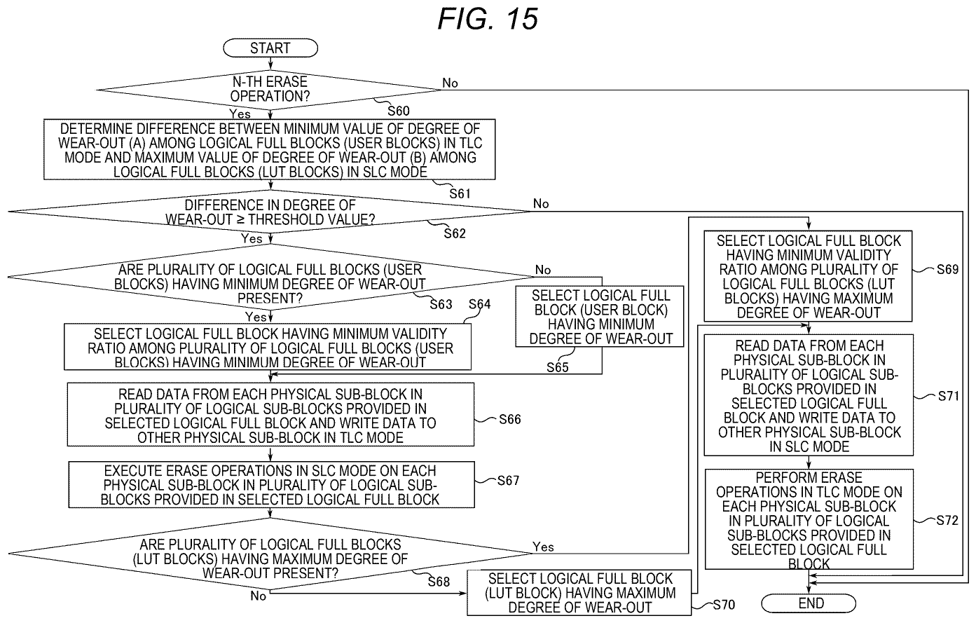

FIG. 14 is a flowchart illustrating processing of the wear leveling between LUT blocks in the memory system according to the third embodiment. The processing shown in FIG. 14 is executed, for example, in response to the completion of the erase operation on a certain logical sub-block LSB used as the LUT block.

### (Step S50)

Similar to the processing of Step S40 described with reference to FIG. 13, if the total number of erase operations reaches N due to the erase operation executed on a certain logical sub-block LSB as shown “Yes” in Step S50, the memory controller 10 resets the total number of erase operations to 0, and the processing executed by the memory controller 10 proceeds to Step S51. If the total number of erase operations does not reach N as shown “No” in Step S50, the processing executed by the memory controller 10 ends.

### (Step S51)

Similar to the processing of Step S41 described with reference to FIG. 13, the memory controller 10 searches for a logical sub-block LSB as the target of the wear leveling. Specifically, the memory controller 10 determines the difference in degree of wear-out between the plurality of logical sub-blocks LSB used as the LUT blocks in the same storage mode.

### (Step S52)

If the difference in degree of wear-out is equal to or greater than the threshold value (threshold value ThE) as shown “Yes” in Step S52, the processing executed by the memory controller 10 proceeds to Step S53. In such a case, wear leveling without the mode change is executed. If the difference in degree of wear-out is smaller than the threshold value (threshold value ThE) as shown “No” in Step S52, the processing executed by the memory controller 10 ends.

### (Step S53)

Similar to the processing of Step S43 described with reference to FIG. 13, the memory controller 10 checks whether a plurality of logical sub-blocks LSB having the minimum degree of wear-out are present among the plurality of logical sub-blocks LSB used as the LUT blocks in the same storage mode.

### (Step S54)

If the plurality of logical sub-blocks LSB having the minimum degree of wear-out are present as shown “Yes” in Step S53, the memory controller 10 searches for a logical block as a target of the wear leveling, similar to the processing of Step S44 described with reference to FIG. 13. Specifically, the memory controller 10 selects a logical sub-block LSB having the minimum validity ratio among the plurality of logical sub-blocks LSB having the minimum degree of wear-out as a target of the wear leveling.

### (Step S55)

If a plurality of logical sub-blocks LSB having the minimum degree of wear-out are not present as shown “No” in Step S53, the memory controller 10 selects the logical sub-block LSB having the minimum degree of wear-out as a target of the wear leveling, similar to the processing of Step S45 described with reference to FIG. 13.

### (Step S56)

Similar to the processing of Step S46 described with reference to FIG. 13, the memory controller 10 executes the wear leveling on the selected logical sub-block LSB.

### (Step S57)

Similar to the processing of Step S47 described with reference to FIG. 13, the memory controller 10 designates the same storage mode as before to each physical sub-block SB in the logical sub-block LSB which is set as the free logical sub-block, and executes the erase operation thereon. The logical sub-block LSB on which the erase operation is executed is used as an LUT block in the same storage mode as before. The logical sub-block LSB having the minimum degree of wear-out is used as the LUT block for writing a new entry. Over time, it is expected that the degree of wear-out of the logical sub-block LSB and the degree of wear-out of other logical sub-blocks LSB will become equalized (leveled).

The erase operation is not executed on another logical sub-block LSB provided in a logical full block LFB that includes the logical sub-block LSB as the target of the wear leveling. Therefore, the storage mode of the other logical sub-blocks LSB does not change before and after the wear leveling is executed on the target logical sub-block LSB.

As described above, the wear leveling between LUT blocks ends in the memory system according to the third embodiment.

(b-3) Wear Leveling Between User Block and LUT Block

FIG. 15 is a flowchart illustrating processing of the wear leveling between a user block and an LUT block in the memory system according to the third embodiment. The processing shown in FIG. 15 is executed, for example, in response to the completion of the erase operation on a certain logical sub-block LSB used as the user block in the TLC mode, or the completion of the erase operation on a certain logical sub-block LSB used as the LUT block in the SLC mode.

### (Step S60)

Similar to the processing of Step S40 described with reference to FIG. 13, if the total number of erase operations reaches N due to the erase operation executed on a certain logical sub-block LSB as shown “Yes” in Step S60, the memory controller 10 resets the total number of erase operations to 0, and the processing executed by the memory controller 10 proceeds to Step S61. If the total number of erase operations does not reach N as shown “No” in Step S60, the processing executed by the memory controller 10 ends.

### (Step S61)

The memory controller 10 refers to the management table TBL2 relating to the degree of wear-out of the logical block. Then, the memory controller 10 searches for a logical full block LFB as a target of the wear leveling based on the degree of wear-out of the logical full block LFB. Specifically, the memory controller 10 determines the difference in degree of wear-out between a logical full block LFB used as the user block in the TLC mode and a logical full block LFB used as the LUT block in the SLC mode. For example, the memory controller 10 determines the difference between the minimum value (A) of the degrees of wear-out of the plurality of logical full blocks LFB used as the user blocks in the TLC mode and the maximum value (B) of the degrees of wear-out of the plurality of logical full blocks LFB used as the LUT blocks in the SLC mode.

### (Step S62)

If the difference in degrees of wear-out is equal to or greater than a threshold value (threshold value ThF) as shown “Yes” in Step S62, the processing executed by the memory controller 10 proceeds to Step S63. In such a case, the wear leveling with the mode change is executed. If the difference in degrees of wear-out is smaller than the threshold value (threshold value ThF) as shown “No” in Step S62, the processing executed by the memory controller 10 ends.

### (Step S63)

The memory controller 10 refers to the management table TBL2 relating to the degrees of wear-out of logical blocks. Then, the memory controller 10 checks whether a plurality of logical full blocks LFB having the minimum degrees of wear-out are present among the plurality of logical full blocks LFB used as the user blocks in the TLC mode. If the plurality of logical full blocks LFB having the minimum degree of wear-out are present as shown “Yes” in Step S63, the processing executed by the memory controller 10 proceeds to Step S64. If the plurality of logical full blocks LFB having the minimum degree of wear-out are not present as shown “No” in Step S63, the processing executed by the memory controller 10 proceeds to Step S65.

### (Step S64)

If the plurality of logical full blocks LFB having the minimum degree of wear-out are present as shown “Yes” in Step S63, the memory controller 10 refers to the management table TBL1 relating to the validity ratio of the logical block. Then, the memory controller 10 searches for a logical block as a target of the wear leveling based on the validity ratio of the logical block. Specifically, the memory controller 10 selects a logical full block LFB having the minimum validity ratio, as a target of the wear leveling, from the plurality of logical full blocks LFB having the minimum degree of wear-out.

### (Step S65)

If the plurality of logical full blocks LFB having the minimum degree of wear-out are not present as shown “No” in Step S63, the memory controller 10 selects the logical full block LFB having the minimum degree of wear-out as a target of the wear leveling.

### (Step S66)

The memory controller 10 executes the wear leveling on the selected logical full block LFB. Specifically, the memory controller 10 reads the valid data from each physical sub-block SB in the plurality of logical sub-blocks LSB provided in the selected logical full block LFB. The read valid data is written to other physical sub-block(s) SB in the TLC mode. The memory controller 10 sets the logical sub-block LSB from which all the valid data is read as a free logical sub-block.

### (Step S67)

The memory controller 10 designates the SLC mode to each physical sub-block SB in the logical sub-block LSB set in the free logical sub-block (that is, all the logical sub-blocks LSB provided in the logical full block LFB selected as a target of the wear leveling), and executes the erase operation thereon. In such a case, the storage mode of the logical full block LFB selected as the target of the wear leveling changes from the TLC mode to the SLC mode. Each logical sub-block LSB on which the erase operation is executed is used as an LUT block in the SLC mode. The logical full block LFB having the minimum degree of wear-out (the user block in the TLC mode) is used as an LUT block for writing a new entry. Over time, it is expected that the degree of wear-out of the logical full block LFB and the degree of wear-out of other logical full blocks LFB will become equalized (leveled).

### (Step S68)

The memory controller 10 refers to the management table TBL2 relating to the degree of wear-out of logical blocks. Then, the memory controller 10 checks whether a plurality of logical full blocks LFB having the maximum degree of wear-out are present among the plurality of logical full blocks LFB used as the LUT blocks in the SLC mode. If the plurality of logical full blocks LFB having the maximum degree of wear-out are present as shown “Yes” in Step S68, the processing executed by the memory controller 10 proceeds to Step S69. If the plurality of logical full blocks LFB having the maximum degree of wear-out are not present as shown “No” in Step S68, the processing executed by the memory controller 10 proceeds to Step S70.

### (Step S69)

If the plurality of logical full blocks LFB having the maximum degree of wear-out are present as shown “Yes” in Step S68, the memory controller 10 refers to the management table TBL1 relating to the validity ratio of logical blocks. Then, the memory controller 10 searches for a logical block as a target of the wear leveling based on the validity ratio of logical blocks. Specifically, the memory controller 10 selects a logical full block LFB having the minimum validity ratio, as a target of the wear leveling, from the plurality of logical full blocks LFB having the maximum degree of wear-out.

### (Step S70)

If the plurality of logical full blocks LFB having the maximum degree of wear-out are not present as shown “No” in Step S68, the memory controller 10 selects the logical full block LFB having the maximum degree of wear-out as a target of the wear leveling.

### (Step S71)

The memory controller 10 executes the wear leveling on the selected logical full block LFB. Specifically, the memory controller 10 reads the valid data from each physical sub-block SB in the plurality of logical sub-blocks LSB provided in the selected logical full block LFB. The read valid data is written to other physical sub-block(s) SB in the SLC mode. The memory controller 10 sets the logical sub-block LSB from which all the valid data is read as a free logical sub-block.

### (Step S72)

The memory controller 10 designates the TLC mode to each physical sub-block SB in the logical sub-block LSB set as the free logical sub-block (that is, all the logical sub-blocks LSB provided in the logical full block LFB selected as a target of the wear leveling), and executes the erase operation thereon. In such a case, the storage mode of the logical full block LFB selected as the target of the wear leveling changes from the SLC mode to the TLC mode. Each logical sub-block LSB on which the erase operation is executed is used as a user block in the TLC mode. The logical full block LFB having the maximum degree of wear-out (the LUT block in the SLC mode) is used as a user block for writing new user data. Over time, it is expected that the degree of wear-out of the logical full block LFB and the degree of wear-out of other logical full blocks LFB will become equalized (leveled).

As described above, the wear leveling between the user block and the LUT block ends in the memory system according to the third embodiment.

### MODIFICATION EXAMPLE

In the processing of Step S43 described with reference to FIG. 13, the memory controller 10 checks whether a plurality of logical sub-blocks LSB having the minimum degree of wear-out are present among the plurality of logical sub-blocks LSB used as the user blocks in the same storage mode. However, the method of selecting a logical sub-block LSB as a target of the wear leveling is not limited thereto. For example, the memory controller 10 may check whether a plurality of logical sub-blocks LSB are present which have the degrees of wear-out ranging from the minimum degree of wear-out to a degree of wear-out that is a first value greater than the minimum degree of wear-out. If the plurality of logical sub-blocks LSB having the degrees of wear-out in the range are present, the memory controller 10 selects a logical sub-block LSB having the minimum validity ratio among the plurality of logical sub-blocks LSB as a target of the wear leveling. The same applies to the processing of Step S53 described with reference to FIG. 14.

In the processing of Step S63 described with reference to FIG. 15, the memory controller 10 checks whether a plurality of logical full blocks LFB having the minimum degree of wear-out are present among the plurality of logical full blocks LFB used as the user blocks in the TLC mode. However, the method of selecting a logical full block LFB as a target of the wear leveling is not limited thereto. For example, the memory controller 10 may check whether a plurality of logical full blocks LFB are present which have the degrees of wear-out ranging from the minimum degree of wear-out to a degree of wear-out that is a second value greater than the minimum degree of wear-out. If the plurality of logical full blocks LFB having the degrees of wear-out in the range are present, the memory controller 10 selects a logical full block LFB having the minimum validity ratio among the plurality of logical full blocks LFB as a target of the wear leveling.

In the processing of Step S68 described with reference to FIG. 15, the memory controller 10 checks whether a plurality of logical full blocks LFB having the maximum degree of wear-out are present among the plurality of logical full blocks LFB used as the LUT blocks in the SLC mode. However, the method of selecting a logical full block LFB as a target of the wear leveling is not limited thereto. For example, the memory controller 10 may check whether a plurality of logical full blocks LFB are present which have the degrees of wear-out ranging from the maximum degree of wear-out to a degree of wear-out that is a third value smaller than the maximum degree of wear-out. If the plurality of logical full blocks LFB having the degrees of wear-out in the range are present, the memory controller 10 selects a logical full block LFB having the minimum validity ratio among the plurality of logical full blocks LFB as a target of the wear leveling.

In the processing of Step S61 described with reference to FIG. 15, the memory controller 10 calculates the difference between the minimum value (A) of the degrees of wear-out of the plurality of logical full blocks LFB used as the user blocks in the TLC mode and the maximum value (B) of the degrees of wear-out of the plurality of logical full blocks LFB used as the LUT blocks in the SLC mode. However, the method of determining whether to perform wear leveling is not limited thereto. Instead of the minimum value (A), the average value of the respective degrees of wear-out of the plurality of logical full blocks LFB used as the user blocks in the TLC mode may be used. Instead of the minimum value (B), the average value of the respective degrees of wear-out of the plurality of logical full blocks LFB used as the LUT blocks in the SLC mode may be used.

### (c) Summary

The memory system 1 according to the third embodiment selects a logical block as a target of the wear leveling based on the degrees of wear-out of the logical blocks. Thereby, the memory system 1 according to the third embodiment is able to equalize the degrees of wear-out among the logical blocks.

Therefore, the memory system 1 according to the third embodiment is able to improve the performance and lifetime of the memory system.

### (4) Others

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system comprising:
a nonvolatile memory that includes a plurality of physical full blocks, each of the plurality of physical full blocks including a plurality of physical sub-blocks; and
a memory controller that is electrically connected to the nonvolatile memory, and configured to:
execute a data erase operation independently for each of the plurality of physical sub-blocks in each of the plurality of physical full blocks; and
in each of the plurality of physical full blocks, set all of the plurality of physical sub-blocks therein to a same storage mode, wherein
the storage mode set for a physical sub-block indicates the number of bits of data stored in a memory cell thereof.

2. The memory system according to claim 1, wherein
the plurality of physical full blocks includes at least a first physical full block and a second physical full block, and each of the plurality of physical full blocks includes at least a first physical sub-block and a second physical sub-block, and
the memory controller is further configured to:
manage the first physical sub-block of the first physical full block and the first physical sub-block of the second physical full block as a first logical sub-block;
manage the second physical sub-block of the first physical full block and the second physical sub-block of the second physical full block as a second logical sub-block;
set the same storage mode to all the logical sub-blocks in the first logical sub-block including the first physical sub-block of the first physical full block and the first physical sub-block of the second physical full block; and
set the same storage mode to all the logical sub-blocks in the second logical sub-block including the second physical sub-block of the first physical full block and the second physical sub-block of the second physical full block.

3. The memory system according to claim 2, wherein
the memory controller is further configured to:
execute the data erase operation, collectively, on all the logical sub-blocks in the first logical sub-block including the first physical sub-block of the first physical full block and the first physical sub-block of the second physical full block; and
execute the data erase operation, collectively, on all the logical sub-blocks in the second logical sub-block including the second physical sub-block of the first physical full block and the second physical sub-block of the second physical full block.

4. The memory system according to claim 2, wherein
the memory controller is further configured to:
manage, as a first logical full block, a set that includes the first logical sub-block and the second logical sub-block; and
execute the data erase operation, collectively, on the first logical sub-block and the second logical sub-block, which are provided in the first logical full block.

5. The memory system according to claim 1, wherein
the memory controller is further configured to:
manage a plurality of logical full blocks, each of which includes at least two physical full blocks among the plurality of physical full blocks;
manage a plurality of logical sub-blocks, each of which includes at least two physical sub-blocks among the plurality of physical sub-blocks; and
in each of the plurality of logical sub-blocks, set the at least two physical sub-blocks provided therein to the same storage mode, and
the number of the plurality of physical sub-blocks provided in each of the plurality of physical full blocks is equal to the number of the plurality of logical sub-blocks provided in each of the plurality of logical full blocks.

6. The memory system according to claim 1, wherein
the memory controller is further configured to:
manage a plurality of logical full blocks, each of which includes at least two physical full blocks among the plurality of physical full blocks;
manage a plurality of logical sub-blocks, each of which includes at least two physical sub-blocks among the plurality of physical sub-blocks; and
in each of the plurality of logical sub-blocks, set all of the at least two physical sub-blocks provided therein to the same storage mode, and
all of the at least two physical sub-blocks provided in each of the plurality of logical sub-blocks are included in only one of the plurality of logical full blocks.

7. The memory system according to claim 1, wherein
the memory controller is further configured to:
manage a plurality of logical full blocks, each of which includes at least two physical full blocks among the plurality of physical full blocks;
manage a plurality of logical sub-blocks, each of which includes at least two physical sub-blocks among the plurality of physical sub-blocks; and
select a logical full block or a logical sub-block to be a target of garbage collection based on at least valid data ratios of the plurality of logical full blocks and valid data ratios of the plurality of logical sub-blocks.

8. The memory system according to claim 7, wherein
the plurality of logical sub-blocks includes at least a first logical sub-block set to a first storage mode, the plurality of logical full blocks includes at least a first logical full block set to a second storage mode different from the first storage mode, and
the memory controller is further configured to:
compare a first valid data ratio which is the valid data ratio of the first logical sub-block, with a second valid data ratio which is the valid data ratio of the first logical full block;
select the first logical sub-block as the target of the garbage collection when the first valid data ratio is equal to or smaller than the second valid data ratio; and
select the first logical full block as the target of the garbage collection when the first valid data ratio is greater than the second valid data ratio.

9. The memory system according to claim 8, wherein
the memory controller is further configured to, when the first valid data ratio is equal to or smaller than the second valid data ratio,
copy, in the first storage mode, valid data from the first logical sub-block to a physical sub-block, which is not provided in the first logical sub-block among the plurality of physical sub-blocks; and
execute the data erase operation in the first storage mode on the first logical sub-block after copying the valid data.

10. The memory system according to claim 8, wherein
the memory controller is further configured to, when the first valid data ratio is greater than the second valid data ratio,
copy, in the second storage mode, valid data from the first logical full block to a physical sub-block in a physical full block, which is not provided in the first logical full block among the plurality of physical full blocks; and
execute the data erase operation in the first storage mode on the first logical full block after copying the valid data.

11. The memory system according to claim 8, wherein
the memory controller is further configured to:
determine the number of logical sub-blocks in which valid data is not stored among logical sub-blocks set to the first storage mode; and
in response to the number being equal to or smaller than a first threshold value, compare the first valid data ratio with the second valid data ratio.

12. The memory system according to claim 7, wherein
the plurality of logical sub-blocks includes a plurality of first logical sub-blocks each set to a first storage mode, and
the memory controller is further configured to:
determine the number of logical sub-blocks in which valid data is not stored among the plurality of first logical sub-blocks; and
in response to the number being equal to or smaller than a second threshold value, select, as the target of the garbage collection, a logical sub-block of which the valid data ratio is minimum among the plurality of first logical sub-blocks.

13. The memory system according to claim 1, wherein
the memory controller is further configured to:
manage a plurality of logical full blocks, each of which includes at least two physical full blocks among the plurality of physical full blocks;
manage a plurality of logical sub-blocks, each of which includes at least two physical sub-blocks among the plurality of physical sub-blocks; and
select a logical full block or a logical sub-block to be a target of wear leveling, based on at least degrees of wear-out of the plurality of logical full blocks and degrees of wear-out of the plurality of logical sub-blocks.

14. The memory system according to claim 13, wherein
the plurality of logical sub-blocks includes at least a first logical sub-block and a second logical sub-block, a first storage mode being set to the first logical sub-block and the second logical sub-block, the degree of wear-out of the second logical sub-block is minimum among two or more of the plurality of logical sub-blocks set to the first storage mode, and
the memory controller is further configured to:
calculate a first difference between a first degree of wear-out and a reference degree of wear-out, the first degree of wear-out being the wear-out of the first logical sub-block; and
in response to the first difference being equal to or greater than a third threshold value, select the second logical sub-block as the target of the wear leveling.

15. The memory system according to claim 14, wherein
the memory controller is further configured to, when the first difference is equal to or greater than the third threshold value:
copy, in the first storage mode, valid data from the second logical sub-block to a physical sub-block which is not provided in the second logical sub-block among the plurality of physical sub-blocks; and
execute the data erase operation in the first storage mode on the second logical sub-block after copying the valid data.

16. The memory system according to claim 14, wherein
the memory controller is further configured to:
manage valid data ratios of the plurality of logical sub-blocks; and
when a plurality of the second logical sub-blocks are included in the two or more of the plurality of logical sub-blocks set to the first storage mode, select, as the target of the wear leveling, a logical sub-block of which the valid data ratio is minimum among the plurality of the second logical sub-blocks.

17. The memory system according to claim 13, wherein
the plurality of logical full blocks includes at least a first logical full block set to a first storage mode, a second logical full block set to a second storage mode different from the first storage mode, and a third logical full block set to the first storage mode of which the degree of wear-out is minimum among two or more of the plurality of logical full blocks set to the first storage mode, and
the memory controller is further configured to:
calculate a second difference between a first degree of wear-out and a second degree of wear-out, the first degree of wear-out being the wear-out of the first logical full block, the second degree of wear-out being the wear-out of the second logical full block; and
in response to the second difference being equal to or greater than a fourth threshold value, select, as the target of the wear leveling, the third logical full block.

18. The memory system according to claim 17, wherein
the memory controller is further configured to, when the second difference is equal to or greater than the fourth threshold value:
copy, in the first storage mode, valid data from the third logical full block to a physical sub-block in a physical full block which is not provided in the third logical full block among the plurality of physical full blocks; and
execute the data erase operation in the second storage mode on the third logical full block after copying the valid data.

19. The memory system according to claim 18, wherein
the plurality of logical full blocks further includes a fourth logical full block set to the second storage mode of which the degree of wear-out is maximum among two or more of the plurality of logical full blocks set to the second storage mode, and
the memory controller is further configured to, when the second difference is equal to or greater than the fourth threshold value,
select, as the target of the wear leveling, the fourth logical full block.

20. The memory system according to claim 19, wherein
the memory controller is further configured to:
copy, in the second storage mode, valid data from the fourth logical full block to a physical sub-block in a physical full block which is not provided in the fourth logical full block among the plurality of physical full blocks; and
execute the data erase operation in the first storage mode on the fourth logical full block after copying the valid data.
